(19) United States
(12) Patent Application Publication
(10) Pub. No.: US 2009/0019110 A1
(43) Pub. Date: Jan. 15, 2009

(54) METHOD, SYSTEM, AND COMPUTER PROGRAM PRODUCT FOR CONTENT DELIVERY SYSTEM

(75) Inventor: Hiroaki Suzuki, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/171,290

(22) Filed: Jul. 10, 2008

(30) Foreign Application Priority Data
Jul. 10, 2007 (JP) 2007180486

(51) Int. Cl. G06F 15/16

(52) U.S. Cl. 709/203

(57) ABSTRACT

A content delivery system has a browsing terminal and a content delivery apparatus. The browsing terminal includes a content storage device, an identification storage device, a content selection device, an identification selection device, and a request transmission device. The content storage device stores first contents, which are related to second contents. The identification storage device stores at least one identifier, and at least one of the at least one identifier is related to a second content. The content selection device selects a first content from the content storage device. The identification selection device selects each of the identifiers that identify second contents which are related to the selected first content. The request transmission device transmits a request for the second contents that are related to the selected first content. The content delivery apparatus transmits the second contents in response to the request.

### CROSS-REFERENCE TO RELATED APPLICATION

This application claims priority to Japanese Patent Application No. 2007-180486, filed Jul. 10, 2007, the disclosure of which is herein incorporated by reference in its entirety.

### BACKGROUND

1. Field of the Invention

The invention relates to a content delivery system comprising a browsing terminal and a content delivery apparatus, a browsing terminal included in a content delivery system, a method of delivering contents, and a computer readable medium storing a content delivery request control program that operates in a browsing terminal.

2. Description of the Related Art

In a known system, in which a server delivers contents, e.g., document data and image data to a terminal of a user via a network, such that a user may browse the delivered contents at the terminal. In a known system, a data delivery system delivers only those articles that are specified in accordance with a request of the user from among a plurality of classified articles in a plurality of general newspapers.

In the above-described conventional data delivery system, however, although preferences of the user are taken into account, an information source, e.g., a newspaper name, and a classification of articles to be delivered are fixed. If the user is interested in an article and wishes to collect and compare information related to the article, which may be taken from a plurality of viewpoints, the user may not get articles in the same classification from any other information sources. Further, if the user subscribes to other newspapers only to compare various information in those newspapers, unnecessary information also may be delivered. In particular, if a mobile browsing terminal is employed to browse the articles, unnecessary information is undesirable, because data storage capacity of the mobile browsing terminal is limited.

### SUMMARY

Therefore, a need has arisen for methods and systems which deliver contents and related contents efficiently, and while conserving space on a user's system.

In an embodiment of the invention, a content delivery system comprises a browsing terminal comprising a content storage device configured to store at least one first content, wherein at least one of the at least one first content is related to at least one second content, an identification storage device configured to store at least one identifier, wherein each of the at least one identifier identifies one of the at least one second content, and each of the at least one second content is related to at least one of the at least one first content, a content selection device configured to select one of the at least one first content from the content storage device, an identification selection device configured to select each of the at least one identifier which identifies the at least one second content which is related to the selected at least one first content, and a request transmission device configured to transmit a request for the at least one second content which is related to the selected at least one first content, and content delivery apparatus is configured to connect to the browsing terminal, wherein the content delivery apparatus comprises a delivery device configured to transmit the at least one second content which is related to the selected at least one first content in response to the request.

In another embodiment of the invention, a content delivery system comprises a browsing terminal, a content delivery apparatus, and a printer, wherein the browsing terminal is configured to be connected to at least one of the content delivery apparatus and the printer, and the browsing terminal comprises a content storage device configured to store at least one first content, wherein at least one of the at least one first content is related to at least one second content, an identification storage device configured to store at least one identifier, wherein each of the at least one identifier identifies one of the at least one second content, and each of the at least one second content is related to at least one of the at least one first content, a content selection device configured to select one of the at least one first content from the content storage device, an identification selection device configured to select each of the at least one identifier which identifies the at least one second content which is related to the selected at least one first content, and a terminal request transmission device configured to transmit a first delivery request for the at least one second content which is related to the selected at least one first content to the printer, wherein the printer comprises a printing device configured to print at least the selected at least one first content and the at least one second content which is related to the selected at least one first content, and a printer request transmission device configured to transmit a second delivery request to the content delivery apparatus, wherein the second delivery request requests delivery of the at least one second content which is related to the selected at least one first content when the first delivery request is received from the terminal request transmission device, and the content delivery apparatus comprises a delivery device configured to transmit the at least one second content which is related to the selected at least one first content to the printer when the second delivery request is received.

In yet another embodiment of the invention, a browsing terminal comprises a content storage device configured to store at least one first content, wherein at least one of the at least one first content is related to at least one second content, an identification storage device configured to store at least one identifier, wherein each of the at least one identifier identifies one of the at least one second content, and each of the at least one second content is related to at least one of the at least one first content, a content selection device configured to select one of the at least one first content from the content storage device, an identification selection device configured to select each of the at least one identifier which identifies the at least one second content which is related to the selected at least one first content, and a request transmission device configured to transmit a request for the at least one second content which is related to the selected at least one first content.

In still another embodiment of the invention, a method of delivering contents comprises the steps of storing at least one first content, wherein at least one of the at least one first content is related to at least one second content, storing at least one identifier, wherein each of the at least one identifier identifies one of the at least one second content, and each of the at least one second content is related to at least one of the at least one first content, selecting one of the at least one first content, selecting at least one of the at least one identifier which identifies the at least one second content which is related to the selected at least one first content, and each of the at least one second content is related to at least one of the at least one first content, and transmitting a request for the at least one second content which is related to the selected at least one first content to be transmitted, and receiving the at least one second content which is related to the selected at least one first content.

In still a further embodiment of the invention, a computer-readable recording medium having computer readable instructions stored thereon, for enabling a browsing terminal to execute a content delivery request control program, wherein execution of the computer readable instructions enables the browsing terminal to execute the program, including operations comprises the steps of storing at least one first content, wherein at least one of the at least one first content is related to at least one second content, storing at least one identifier, wherein each of the at least one identifier identifies one of the at least one second content, and each of the at least one second content is related to at least one of the at least one first content, selecting one of the at least one first content, selecting each of the at least one identifier which identifies the at least one second content which is related to the selected at least one first content, and transmitting a request for the at least one second content which is related to the selected at least one first content to be transmitted either to the browsing terminal or to a printer.

### BRIEF DESCRIPTION OF THE DRAWINGS

For a more complete understanding of the present invention, the needs satisfied thereby, and the objects, features, and advantages thereof, reference now is made to the following descriptions taken in connection with the accompanying drawings.

FIG. 1 is a system configuration diagram showing an outlined configuration of a content delivery system, according to an embodiment of the invention.

FIG. 2 is a block diagram showing a configuration of a browsing terminal, according to an embodiment of the invention.

FIG. 3 is a table of contents stored in a content information storage area, according to an embodiment of the invention.

FIG. 4 is a table of index information stored in an index information storage area, according to an embodiment of the invention.

FIG. 5 is a table of other index information stored in the index information storage area, according to an embodiment of the invention.

FIG. 6 is a diagram of relative storage areas of a RAM of the browsing terminal, according to an embodiment of the invention.

FIG. 7 is a table of a related content list, according to an embodiment of the invention.

FIG. 8 is a table of a request waiting list, according to an embodiment of the invention.

FIG. 9 is a table of a delivery confirmation list, according to an embodiment of the invention.

FIG. 10 is a block diagram showing an electrical configuration of a server, according to an embodiment of the invention.

FIG. 11 is a flowchart showing main processing performed in a browsing terminal, according to an embodiment of the invention.

FIG. 12 is a flowchart of table-of-contents display processing performed as part of the main processing performed in a browsing terminal, according to an embodiment of the invention.

FIG. 13 is a flowchart of key input processing performed as part of the main processing performed in a browsing terminal, according to an embodiment of the invention.

FIG. 14 is a flowchart of item selection processing performed as part of the key input processing, according to an embodiment of the invention.

FIG. 15 is a flowchart of item determination processing performed as part of the key input processing, according to an embodiment of the invention.

FIG. 16 is a flowchart of page turn-over processing that is performed as part of the key input processing, according to an embodiment of the invention.

FIG. 17 is a flowchart of content request processing that is performed as part of the key input processing, according to an embodiment of the invention.

FIG. 18 is a flowchart of related content list generation processing performed as part of the content request processing, according to an embodiment of the invention.

FIG. 19 is a flowchart of full-text data request processing that is performed as part of the content request processing, according to an embodiment of the invention.

FIG. 20 is a flowchart of network connection update-time processing that is performed as part of the main processing, according to an embodiment of the invention.

FIG. 21 is a flowchart of full-text data reception processing that is performed as part of the main processing, according to an embodiment of the invention.

FIG. 22 is an illustration of a related content display screen, according to an embodiment of the invention.

FIG. 23 is another illustration of the related content display screen, according to an embodiment of the invention.

FIG. 24 is a flowchart of main processing that is performed in the server, according to an embodiment of the invention.

FIG. 25 is a system configuration diagram showing an outlined configuration of a content delivery system, according to another embodiment of the invention.

FIG. 26 is a block diagram showing an electrical configuration of a printer, according to an embodiment of the invention.

FIG. 27 is a diagram of relative storage areas of a RAM of the printer, according to an embodiment of the invention.

FIG. 28 is a flowchart of main processing that is performed in a browsing terminal, according to an embodiment of the invention.

FIG. 29 is a flowchart of item selection processing that is performed as part of the key input processing, according to an embodiment of the invention.

FIG. 30 is a flowchart of item determination processing that is performed as part of the key input processing according to an embodiment of the invention.

FIG. 31 is a flowchart of content request processing that is performed as part of the key input processing according to an embodiment of the invention.

FIG. 32 is a flowchart of printer connection update-time processing that is performed as part of the main processing, according to an embodiment of the invention.

FIG. 33 is an explanatory illustration of an output destination selection screen, according to an embodiment of the invention.

FIG. 34 is an explanatory table of a related content list, according to an embodiment of the invention.

FIG. 35 is an explanatory table of a request waiting list, according to an embodiment of the invention.

FIG. 36 is a flowchart of main processing that is performed in the printer, according to an embodiment of the invention.

FIG. 37 is a flowchart of full-text data request processing that is performed as part of the main processing, according to an embodiment of the invention.

FIG. 38 is a flowchart of full-text data reception processing that is performed as part of the main processing, according to an embodiment of the invention.

FIG. 39 is a flowchart of print processing that is performed as part of the main processing, according to an embodiment of the invention

FIG. 40 is a table of a delivery confirmation list, according to an embodiment of the invention.

FIG. 41 is an explanatory illustration of a printing result of all articles in the related content list, according to an embodiment of the invention.

FIG. 42 is a system configuration diagram showing an outlined configuration of a content delivery system according to still another embodiment of the invention.

FIG. 43 is a table showing an example of the index information according to yet another embodiment of the invention.

### DETAILED DESCRIPTION OF EMBODIMENTS

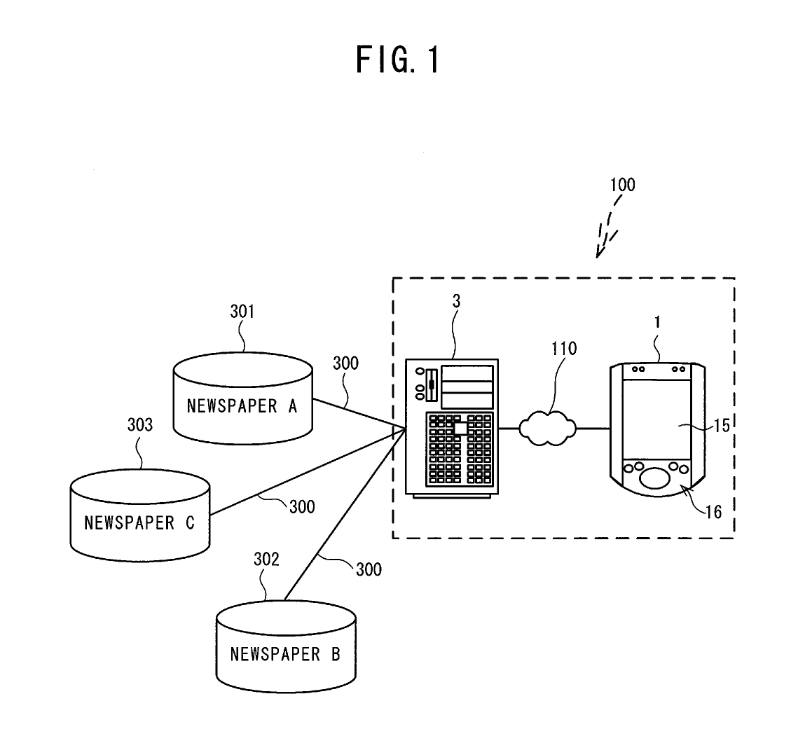

Embodiments of the present invention and their advantages may be understood by referring to FIGS. 1-43, like numerals being used for like corresponding parts in the various drawings.

FIGS. 1-24 describe a content delivery system 100 according to an embodiment of the invention. Specifically, FIG. 1 describes a content delivery system 100 which may comprise a mobile browsing terminal 1. Mobile browsing terminal 1 may comprise a display portion 15 and operation keys 16, and a server 3. Browsing terminal 1 and server 3 may be connected to each other via a wired or wireless network, e.g., via the Internet or a network 110. Although only one browsing terminal 1 is shown in FIG. 1, a plurality of browsing terminals 1 may be connected to server 3. A user may operate browsing terminal 1, and browsing terminal 1 may download a content, e.g., characters, images, or both, from an external device, e.g., server 3, via network 110, and may display the downloaded content on display portion 15. Operation keys 16, which may include arrow keys and a determination key, may be disposed in close proximity to display portion 15 of browsing terminal 1. The user may operate operation keys 16, which may instruct browsing terminal 1 to carry out various operations, including selection of a desired content to be downloaded into browsing terminal 1, and instructions, e.g., delivery requests for download of the content.

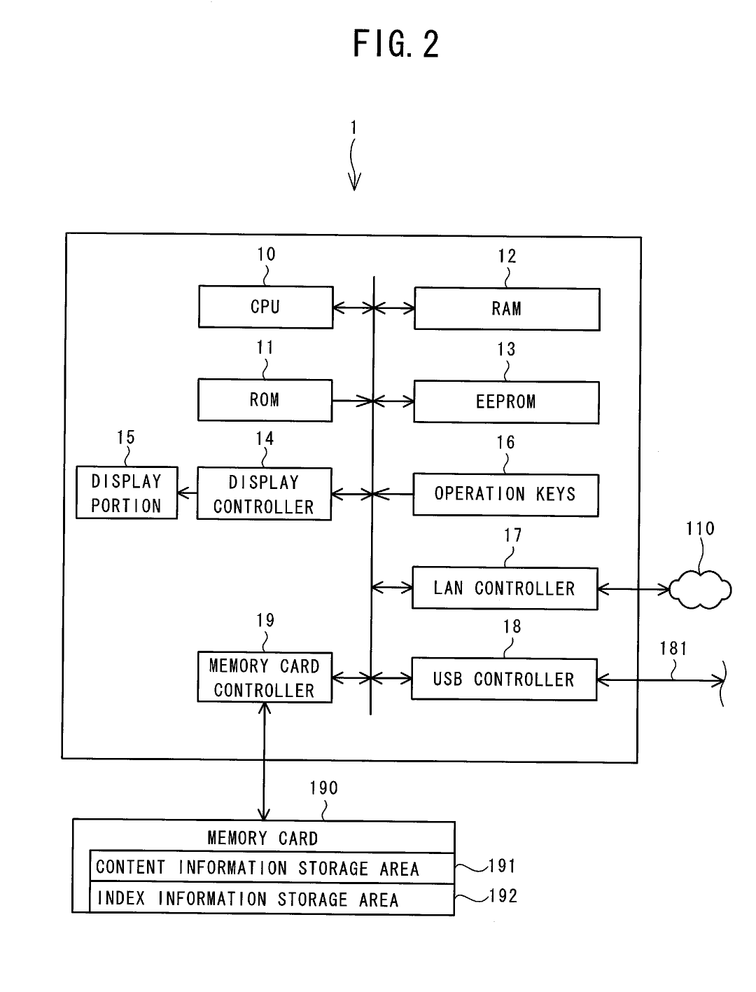

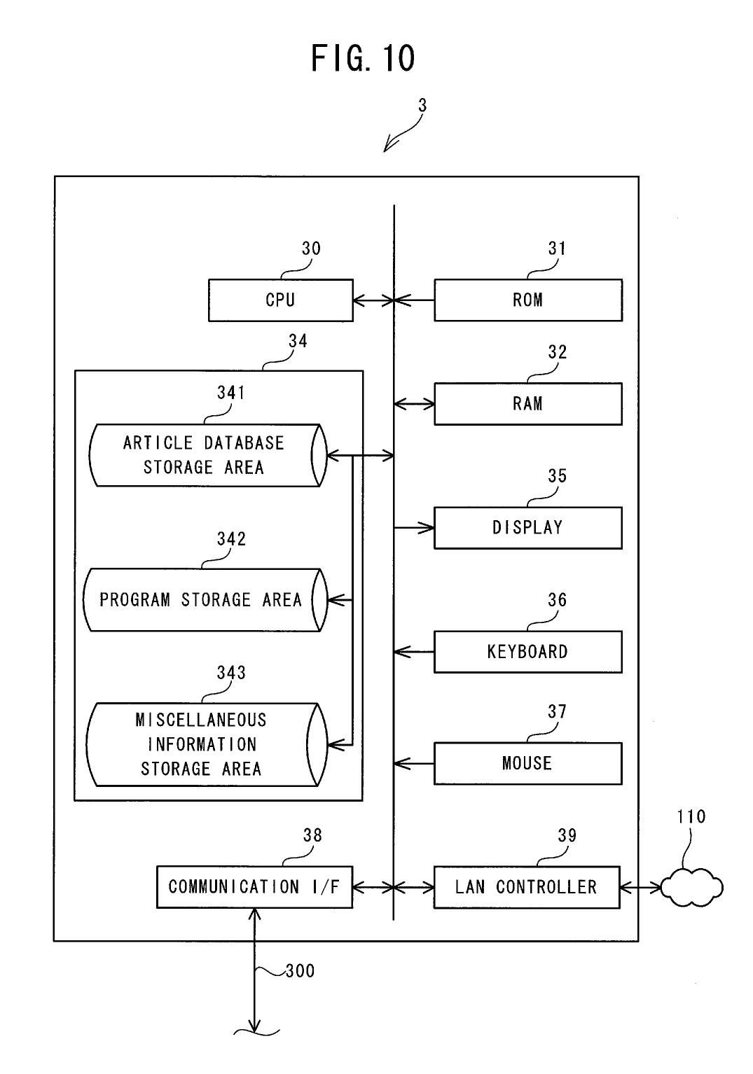

Server 3 may acquire and store the data of various contents from a plurality of information sources via dedicated communication lines 300 that may be separately established. The plurality of information sources may include, for example, a plurality of newspaper companies that respectively publish newspapers, e.g., newspapers A, B, and C. Server 3 periodically may acquire newspaper article data of the newspaper companies that print newspapers A, B, and C from respective article servers 301, 302, and 303 of the newspaper companies via the dedicated lines 300. Referring to FIG. 10, server 3 may store the acquired newspaper article data in a hard disk drive 34. Server 3 may deliver specific article data to browsing terminal 1 in accordance with a preset delivery instruction. For example, if the user of browsing terminal 1 subscribes to the newspaper A, the article data of a subscribed portion of the newspaper A may be delivered to browsing terminal 1 when browsing terminal 1 is connected to server 3 via a network 110. As shown in FIG. 2, the delivered data may be stored into a memory card 190. When server 3 receives an individual content delivery request from browsing terminal 1, server 3 may deliver the data of requested content, e.g., the article, to browsing terminal 1. Although Referring back to FIG. 1, three article servers 301-303 of respective newspaper companies A, B, and C may be illustrated as connected to the server 3. Nevertheless, server 3 may be connected to more article servers.

As shown in FIG. 2, browsing terminal 1 may comprise a CPU 10, a ROM 11, a RAM 12, and an EEPROM 13, a display controller 14, the operation keys 16, a LAN controller 17, a USB controller 18, and a memory card controller 19, all of which may be connected to each other via a bus. ROM 11 may store a variety of programs that may be used to operate browsing terminal 1. CPU 10 may control operations of browsing terminal 1 in accordance with the programs stored in ROM 11. RAM 12 will be described in more detail further herein. EEPROM 13, which may be a nonvolatile memory, may store a user ID.

The stored user ID may be used as identification information of the user of browsing terminal 1, for example. Display controller 14 may control the display portion 15, which may be connected to display controller 14. Operations keys 16 may operate to allow a user to input various operations, as described above. LAN controller 17 may be connected to network 110 to send data to and receive data from an external device, e.g., server 3. USB controller 18 may engage in USB communications to send data to and receive data from an external device, which may be connected via a USB cable. Memory card controller 19 may connect a memory card 190.

Memory card 190 may comprise a content information storage area 191, an index information storage area 192, and the like. Content information storage area 191 may store information on a content. This information, hereinafter interchangeably referred to as “content information” may be displayed on display portion 15, and may be viewed or browsed by the user. The content information may comprise, a content ID that may serve as an identification code unique to each content, a content tile, and full-text data of a body text of the content. In an embodiment of the invention, a user of browsing terminal 1 may subscribe to the newspaper A published by the company A.

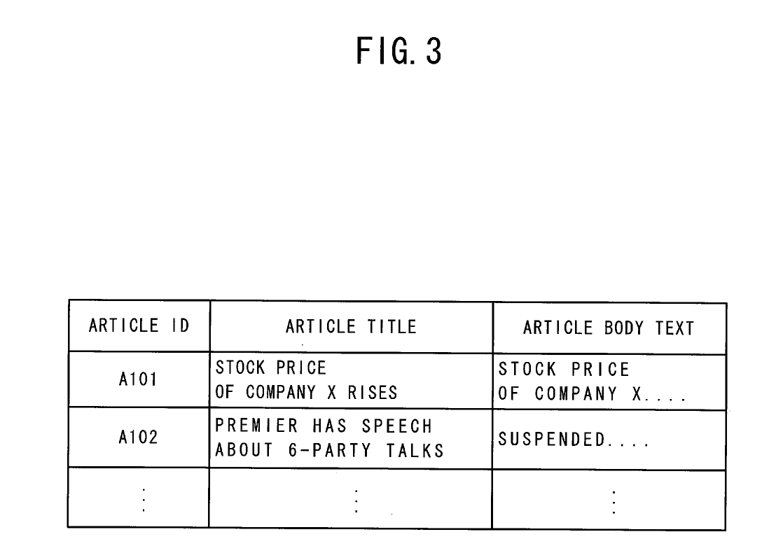

Referring now to FIG. 3, the contents may include articles in newspaper A, which may be stored as content information in content information storage area 191. As shown in FIG. 3, the content information for each article in the newspaper A may include an article ID, e.g., Axxx, in which A may identify newspaper A, and xxx may identify the article number, which is an identification code of the article in the newspaper A, an article title, which is a headline of the article, and data of the body text of the article. A classification of the article, such as general news, economy, or sports, may also be included in the content information. As described above, the content information, e.g., the article data, may be stored into the content information storage area 191 each time a portion, e.g., the newspaper morning edition, that the user may subscribe to, of browsing terminal 1 is delivered from the server 3. In an example shown in FIG. 3, content information of an article having an article ID of “A101”, an article title of “Stock price of Company X rises”, and a body text of “Stock price of Company X . . . ,” an article having an article ID of “A102,” an article title of “Premier has speech about 6-party talks,” and a body text of “Suspended . . . ” already may be delivered from server 3 and stored in content information storage area 191.

Index information storage area 192 of memory card 190 may store information on an article of any other newspaper, e.g., newspapers B or C, which may be related to an article of the newspaper A, hereinafter interchangeably referred to as a “related article.” The related article information may be stored in the content information storage area 191 as index information. When the content information of an article of the newspaper A is delivered to the browsing terminal 1, the index information also may be delivered from server 3, and may be stored into index information storage area 192. In each of the content information and the index information, a tag may be embedded. The tag may be used as additional information which may identify each component item.

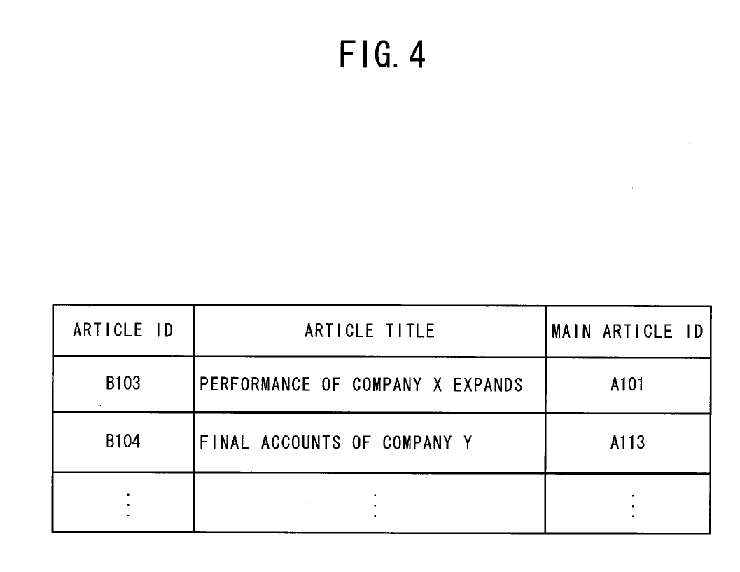

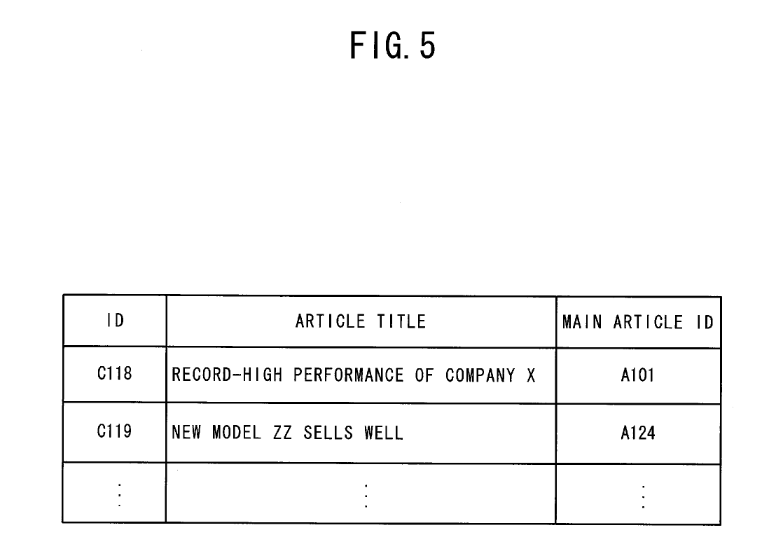

Referring to FIGS. 4 and 5, index information may be used as an index when referencing a related article based on an article ID of an article in the newspaper A, to which the user of the browsing terminal 1 may subscribe. As shown in FIGS. 4 and 5, in the present embodiment, the index information may be created for each of the newspaper companies, other than newspaper A, to which the user of browsing terminal 1 subscribes e.g., newspaper B, which is illustrated in FIG. 4 and newspaper C, which is illustrated in FIG. 5. The index information may include an article ID, an article title, and a main article ID for each of the related articles. The article ID may be an identification code of the related article. For example, each related article may be given a unique code that identifies the article publishing newspaper company (B or C) and the article number, e.g. “xxx”, may be combined to form unique codes “Bxxx” for article number “xxx”, in which “xxx” may be a three-digit article number, for newspaper B or “Cxxx,” which may be a similar identifying system for newspaper C.

The article title may be a headline of the related article. The main article ID may be an article ID of an article in newspaper A, which may correspond to the related article. As shown in FIG. 4, the index information of the newspaper published by the company B comprises a related article ID of “B103”, a related article title of “Performance of Company X expands”, and a main article ID of “A101” as the first index information. Therefore, this article of the newspaper B may be identified as a related article, corresponding to the article having the article ID “A101” of the newspaper A published by company A, shown in FIG. 3. As shown in FIG. 4, if the newspaper B has an article corresponding to any article in the newspaper A, server 3 may create such index information and may deliver the index information simultaneously with the content information of the article in newspaper A to browsing terminal 1. The delivered index information may be stored into index information storage area 192. Similarly, as shown in FIG. 5, index information also may be created for the newspaper C, published by the company C, and may be delivered to browsing terminal 1.

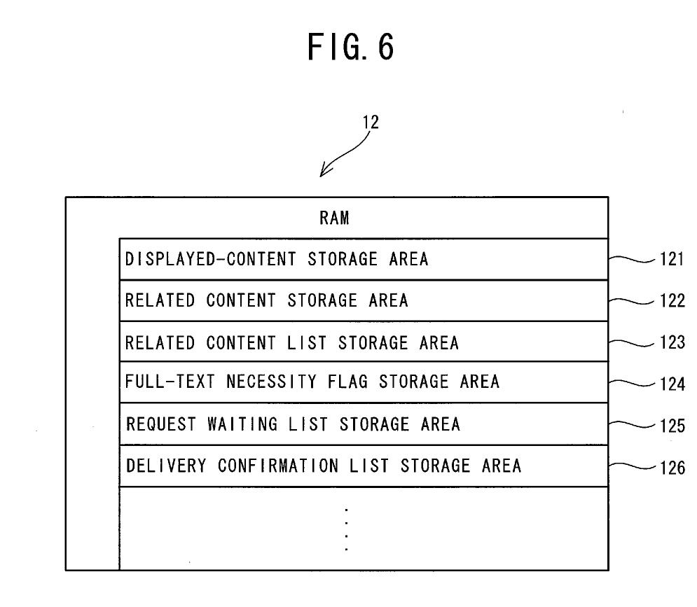

As shown in FIG. 6, RAM 12, may be configured to temporarily store various types, e.g., kinds, of data. RAM 12 may comprise a plurality of storage areas, such as a displayed-content storage area 121, a related content storage area 122, a related content list storage area 123, a full-text necessity flag storage area 124, a request waiting list storage area 125, and a delivery confirmation list storage area 126.

Displayed-content storage area 121 may store, as displayed-content information, the content information of an article whose body text is read out from content information storage area 191 of memory card 190, and displayed on the display portion 15. Related content storage area 122 may store, as related content information, the index information that has an article ID included in the displayed-content information as the main article ID, and that is read out from index information storage area 192 of memory card 190. Specifically, related content storage area 122 may store the index information of each of the newspapers B and C corresponding to the article ID of an article in the newspaper A being displayed.

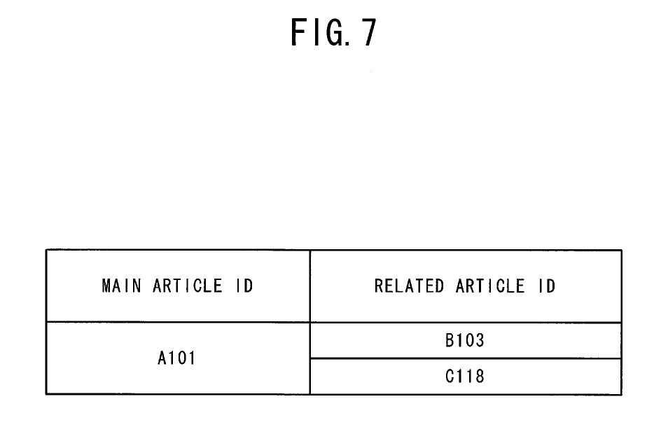

Related content list storage area 123 may store a related content list that associates an article in the newspaper A with an article in any other newspaper, and may use article IDs. As shown in FIG. 7, the related content list may comprise a main article ID and a related article ID. In the related content list, at least one related article is associated with one main article ID. In an example shown in FIG. 7, the related article IDs of “B103” and “C118” may be stored in association with the main article ID “A101.” Therefore, it may be determined that the article of the article ID “A101” in the newspaper A is associated with the two related articles of the article ID “B103” in the newspaper B and the article ID “C118” in the newspaper C.

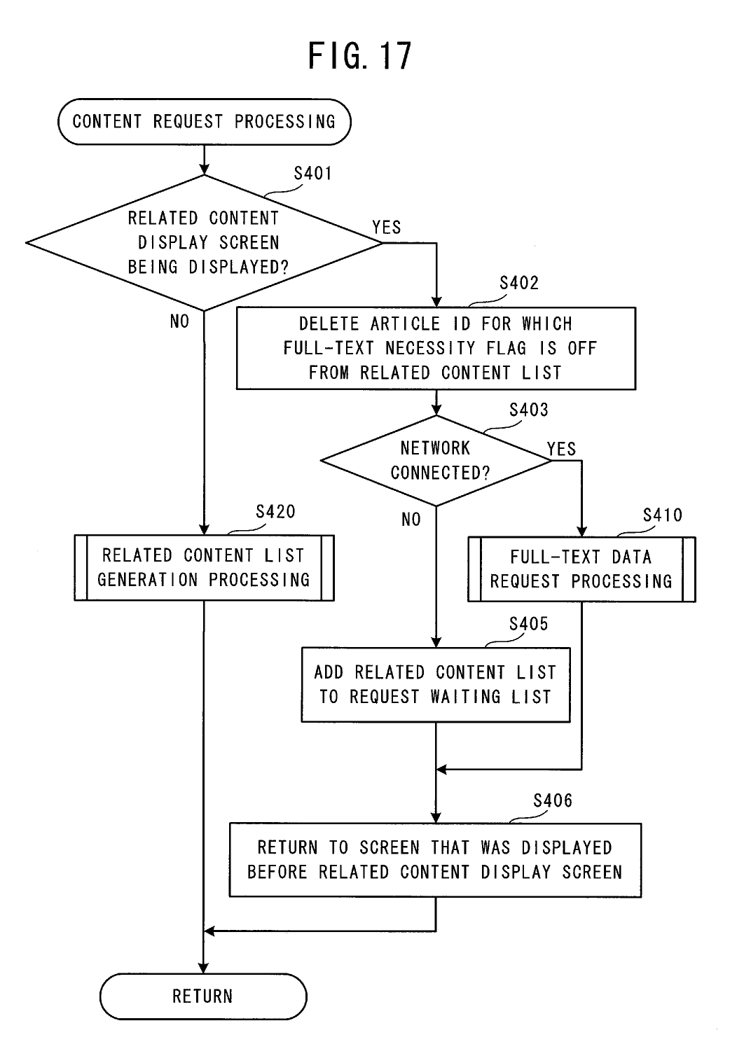

As described in detail later, if content request processing, as shown in FIG. 17, is performed when the body text of an article in the newspaper A is being displayed on display portion 15, a related content list for the article may be generated and stored into related content list storage area 123.

The full-text necessity flag storage area 124 may store full-text necessity flags in association with the main article ID and the related article ID stored in the related content list. The full-text necessity flag may indicate whether to request display of the full text of a body of an article with an ON/OFF state.

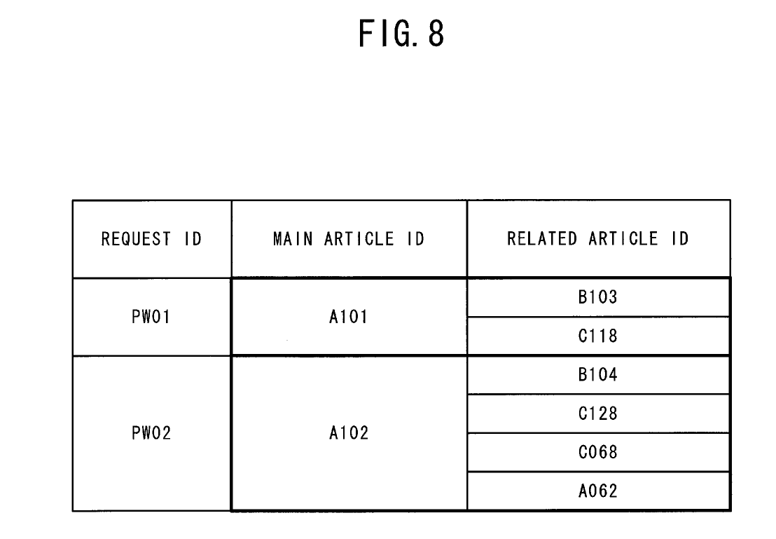

Request waiting list storage area 125 may store a request waiting list that may be prepared when browsing terminal 1 and server 3 are not connected to each other. The request waiting list may be prepared in order to request full-text data of a related article at a future time when browsing terminal 1 is connected to the server 3. As shown in FIG. 8, the request waiting list may comprise a request ID, which may be an identification code given for each related content list, and the related content list, which may comprise a main article ID and a related article ID. As described in detail later, when browsing terminal 1 and server 3 are connected to each other, server 3 may perform processing to request the full-text data of the contents stored in the request waiting list at that time.

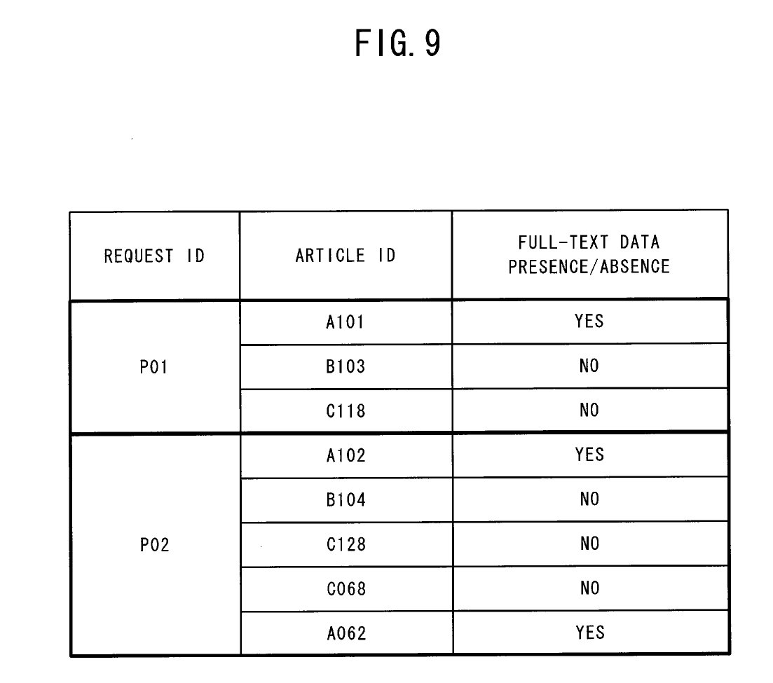

Delivery confirmation list storage area 126 may store a delivery confirmation list that may indicate whether the full-text data of an article is stored in content information storage area 191 of memory card 190. As shown in FIG. 9, the delivery confirmation list may comprise a request ID given for each related content list, article IDs, that is, a main article ID and a related article ID that are included in a related content list, and presence or absence of the full-text data. In FIG. 9, “YES” in a column of the full-text data presence/absence may indicate that the full-text data is stored in content information storage area 191, while “NO” may indicate that the full-text data is not stored in the content information storage area 191. As described in detail herein, if it is determined that full-text data of an article is not stored based on a delivery confirmation list, server 3 may be requested to deliver, e.g., transmit, the full-text data of the article.

As shown in FIG. 10, server 3 may comprise a CPU 30, a ROM 31, a RAM 32, a hard disk drive (“HDD”) 34, a display 35, a keyboard 36, a mouse 37, a communication I/F 38, and a LAN controller 39, which may be connected to each other, e.g., via a bus. ROM 31 may store various programs including e.g., the BIOS, and the like, which may be used to operate server 3. CPU 30 may control operations of server 3 by executing the programs stored in ROM 31. RAM 32 may be a memory used to temporarily store various data and data types.

HDD 34, which may be a storage device, may comprise a plurality of storage areas, e.g., an article database (DB) storage area 341, a program storage area 342, and a miscellaneous information storage area 343. Article DB storage area 341 may store an article DB that may accumulate data of newspaper articles periodically acquired from the article servers 301-303 of the respective newspaper companies A, B, and C, which may be connected via the dedicated line 300 as described above. The data of each of the newspaper articles that is accumulated in the article DB may include an article ID to identify a publishing newspaper company and an article, an article title, full-text data of a body text of the article, and the like. Program storage area 342 may store various programs. Miscellaneous information storage area 343 may store other miscellaneous information.

Communication I/F 38 may be used to connect to article servers 301-303 of the respective newspaper companies A, B, and C via dedicated line 300. LAN controller 39 may connect to network 110, so that data may be transmitted to and received from an external device, e.g., browsing terminal 1. Server 3 also may connect to the article servers 301-303 via network 110, in place of communication I/F 38, for dedicated line 300.

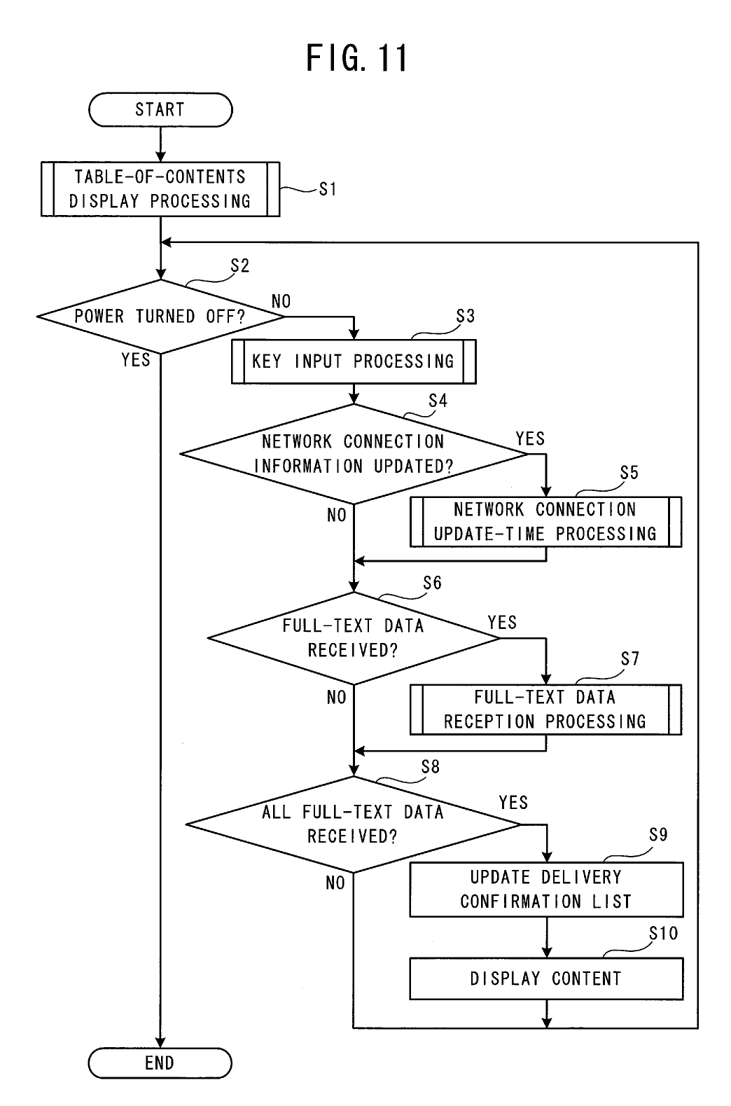

Content delivery system 100 may perform various processes, which are described herein with reference to FIGS. 11-24. First, browsing terminal 1 may perform various processes, as described herein with reference to FIGS. 11-23. CPU 10, in accordance with the programs which may be stored in ROM 11, may perform the processing shown in FIGS. 11-21.

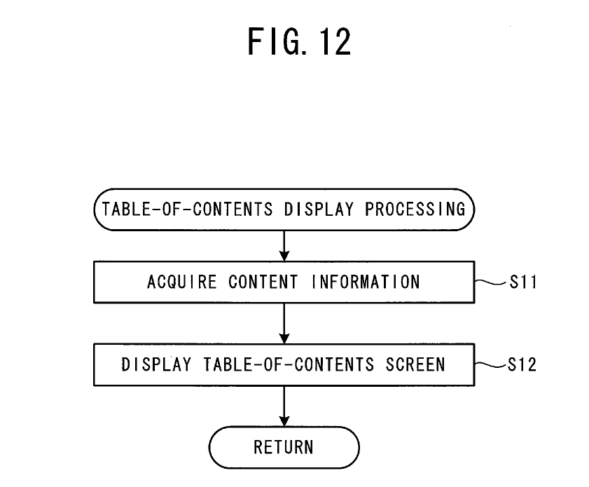

As shown in FIG. 11, When the power of the browsing terminal 1 is turned ON, main processing may begin with the CPU 10, which first may perform a table-of-contents display processing at Step S1, also shown in further detail with respect to FIG. 12. As shown in FIG. 12, in the table-of-contents display processing, CPU 10 first may read out the content information stored in content information storage area 191 of memory card 190 at Step S11. Then, CPU 10 may generate a table-of-contents screen, and may display the generated screen on the display portion 15 at Step S12, and then may return to the main processing of FIG. 11. Referring again to FIG. 11, if the power is turned OFF, e.g., YES at Step S2 after the table-of-contents display processing carried out in Step S1, the CPU 10 may terminate the main processing, as shown at the “END” step of FIG. 11. While the power is not turned OFF, e.g., NO at Step S2, processing of S3-S10, which is described in more detail herein, may be repeated.

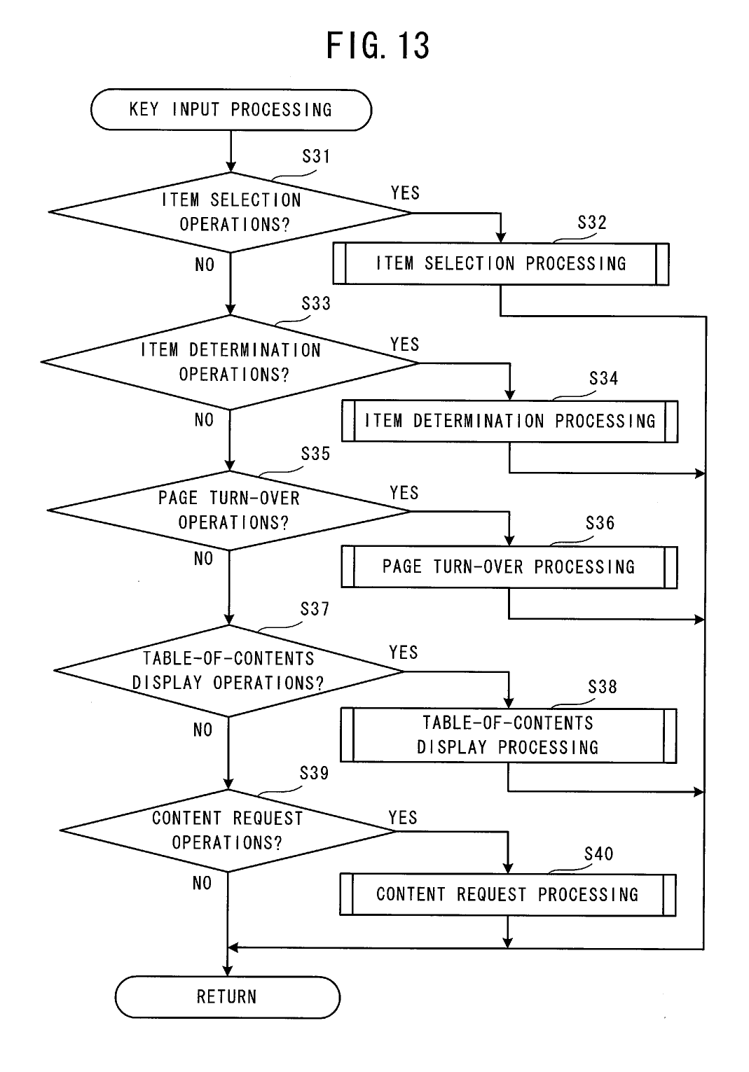

Specifically, CPU 10 first may perform key input processing at Step S3, also shown in further detail with respect to FIG. 13. Key input processing may be described in further detail herein, with reference to FIGS. 13-19. Referring again to FIG. 11, in the key input processing, various functions of the browsing terminal 1 may be invoked in response to inputs from operation keys 16. In an embodiment of the invention, there may be a plurality of, e.g., five, types of processing corresponding to the functions, that is, item selection processing, item determination processing, page turn-over processing, table-of-contents display processing, and content request processing. Nevertheless, in addition to the above-mentioned processing, other processing may be performed in browsing terminal 1.

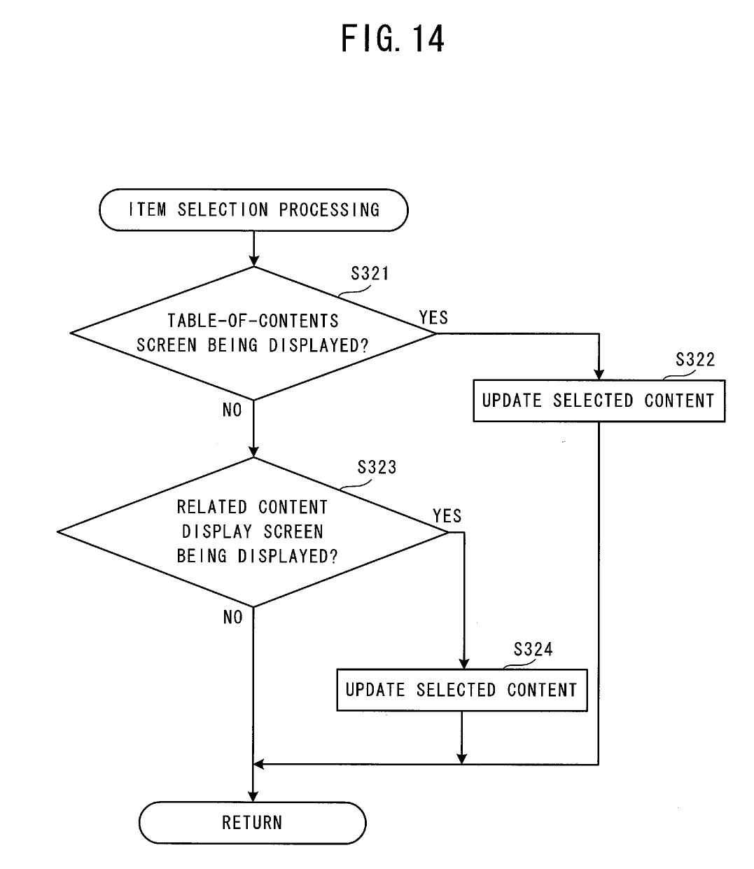

Referring to FIG. 13, following the start of the key input processing, CPU 10 may determine whether item selection operations are to be performed. This determination may be based on whether an arrow key is pressed, in either in the upper position or in the lower position at Step S31. If the arrow key is pressed in either position, e.g., YES at Step S31, CPU 10 may perform the item selection processing at Step S32. Item selection processing is shown in further detail with respect to FIG. 14. As shown in FIG. 14, during item selection processing, CPU 10 first may determine whether the table-of-contents screen is being displayed on display portion 15 at Step S321. If the table-of-contents screen is being displayed, e.g., YES at Step S321, CPU 10 may update a highlight-displayed item, e.g., selected content, among table-of-contents items displayed on display portion 15, with an item selected with the arrow key at Step S322. Then, CPU 10 may return to the key input processing of FIG. 13, and further to the main processing of FIG. 11.

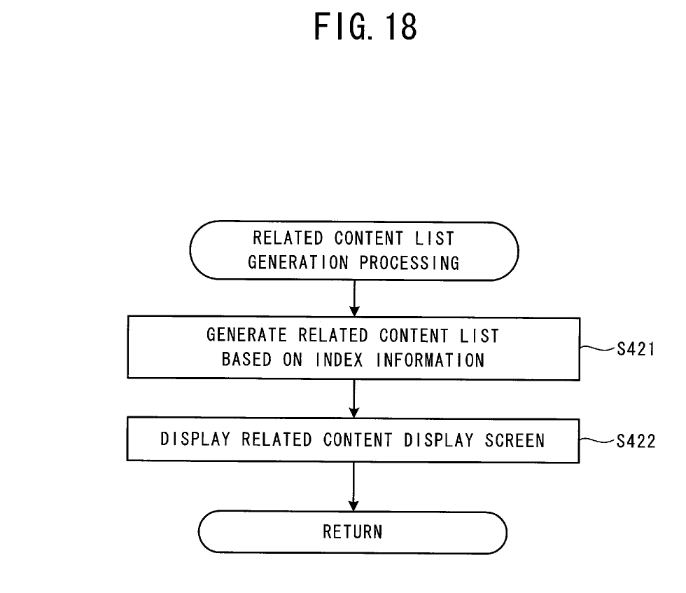

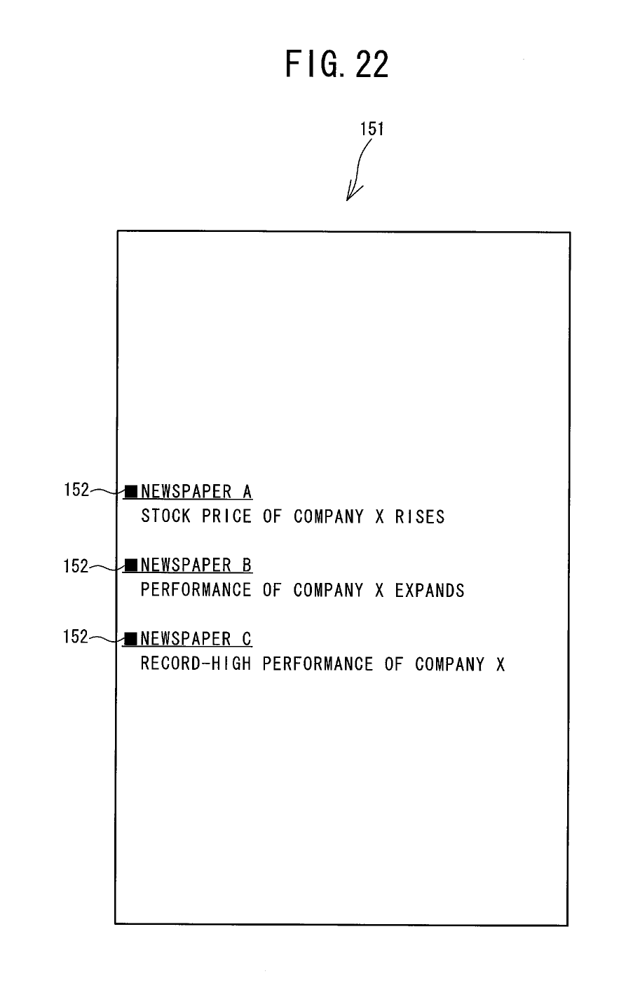

If the table-of-contents screen is not being displayed, e.g., NO at Step S321, CPU 10 may determine whether a related content display screen 151 shown in FIG. 22 is being displayed, at Step S323. Related content display screen 151 may refer to a screen showing a list of titles of the related articles, which may be displayed on display portion 15, based on the related content list generated in related content list generation processing, which will be described in further detail herein with respect to FIG. 18. As described above, the related content list may associate an article of the newspaper A with a related article of any other newspaper, using article IDs. As shown in FIG. 22, related content display screen 151 may display a list of publishing newspaper company names and article titles of one article of the newspaper A and the related articles.

In addition, corresponding to each of the articles, a full-text necessity checkbox 152 may be displayed, which the user may use to select whether to display the full text of the body of the article. If the content request processing, which will be described in further detail herein with respect to FIG. 17 is performed, server 3 may be requested to deliver, e.g., transmit, to browsing terminal 1, the full-text data of the body text of the article for which the full-text necessity checkbox 152 is marked. Referring to FIG. 22, when related content display screen 151 is displayed, full-text necessity checkboxes 152 all may be marked. At the same time, as shown in FIG. 6, the full-text necessity flags for the main article and the related articles in full-text necessity flag storage area 124 of the RAM 12 all may be turned ON.

If the arrow key is pressed either in the upper or lower position when related content display screen 151, as shown in FIG. 22, is being displayed, e.g., YES at Step S323 of FIG. 14, CPU 10 may update a highlight-displayed title, e.g., a selected content in the related article titles list, with a newly selected title with the arrow key, at Step S322. Then, CPU 10 may return to the key input processing of FIG. 13, and further to the main processing of FIG. 11. If related content display screen 151 also is not being displayed, e.g., NO at Step S323, then the key operations may be deemed invalid, and CPU 10 may return to the key input processing of FIG. 13, and then to the main processing of FIG. 11.

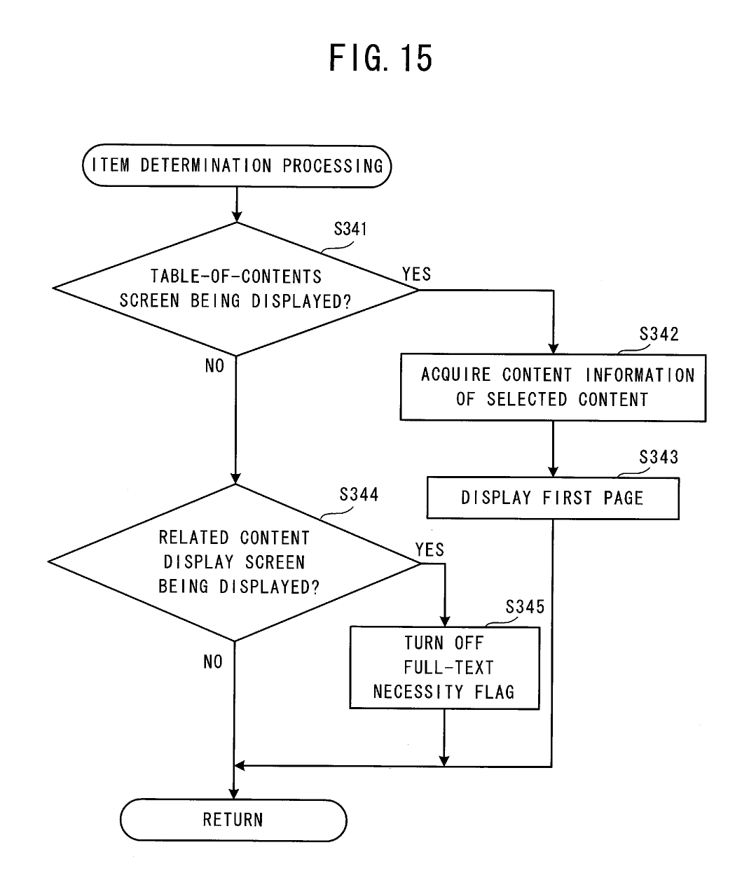

Referring again to the key input processing shown in FIG. 13, if it is determined that the key input does not correspond to the item selection operations by means of the operations of the arrow key in the upper or lower position, e.g., NO at Step S31, CPU 10 may determine whether the key input corresponds to item determination operations by means of a pressing of a determination key, at Step S33. If it is determined that the input corresponds to the item determination operations, e.g., YES at Step S33, CPU 10 may perform the item determination processing at Step S34, which will be described in further detail herein with respect to FIG. 15.

Referring to FIG. 15, CPU 10 first may determine whether the table-of-contents screen is being displayed on display portion 15, at Step S341. If the table-of-contents screen is being displayed, e.g., YES at Step S341, CPU 10 may acquire the content information of a highlight-displayed item, e.g., the selected content, among table-of-contents items displayed on display portion 15, from content information storage area 191 of memory card 190. The acquired content information may be stored in displayed-content storage area 121 of RAM 12 as the displayed-content information, as shown in FIG. 6, in Step S342 of FIG. 15. Based on the acquired content information, CPU 10 may display a first page of the content, e.g., for the first page of a body text of an article in the newspaper A, on display portion 15, at Step S343, and may return to the key input processing of FIG. 13, and then to the main processing of FIG. 11.

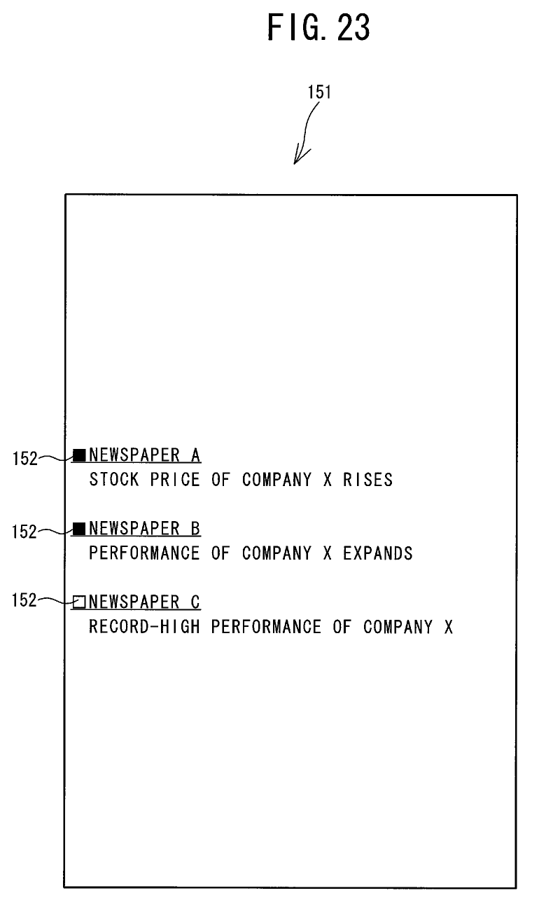

If the table-of-contents screen is not being displayed, e.g., NO at Step S341, CPU 10 may determine whether related content display screen 151 is being displayed at Step S344. If related content display screen 151 is being displayed, e.g., YES at Step S344, CPU 10 may turn the full-text necessity flag of the highlight-displayed selected content among the full-text necessity flags stored in the full-text necessity flag storage area 124 OFF at Step S345. In addition, CPU 10 may clear the corresponding full-text necessity checkbox 152 on related content display screen 151. For example, if the determination key is pressed on the related content display screen 151 of FIG. 22 when the article title “RECORD-HIGH PERFORMANCE OF COMPANY X” of the newspaper C is highlight-displayed, full-text necessity checkbox 152 corresponding to this article may be updated to an unmarked state, as shown in FIG. 23 at Step S345. Then, the CPU 10 may return to the key input processing of FIG. 13, then to the main processing of FIG. 11.

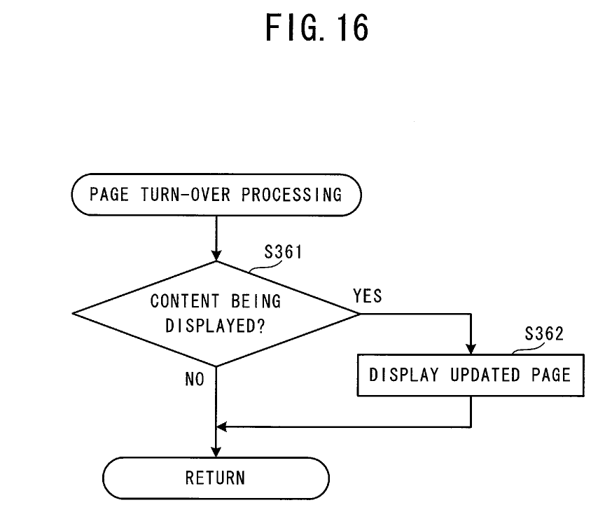

In the key input processing of FIG. 13, if it is determined that the key input does not correspond to the item determination operations by means of the operations of the determination key, e.g., NO at Step S33, CPU 10 may determine whether the input corresponds to page turn-over operations by means of pressing of the arrow key either in the right or left position, at Step S35. If the input corresponds to the operations of the arrow key either in the right or left position, e.g., YES at Step S35, CPU 10 may perform the page turn-over processing, Step S36, which will be described in further detail herein with respect to FIG. 16.

Referring to FIG. 16, CPU 10 first may determine whether a content, e.g., the body text of an article in the newspaper A is being displayed at Step S361. If a content is being displayed, e.g., YES at Step S361, CPU 10 may update the displayed page with another page, e.g., the previous page, or next page, which may correspond to the operations of the arrow key. CPU 10 then may display the updated page on display portion 15 at Step S362, and then may return to the key input processing of FIG. 13, and then to main processing of FIG. 11. If the operations are performed while no content is being displayed, e.g., NO at Step S361, the key operations may be deemed invalid, and CPU 10 may return to the key input processing of FIG. 13, and then to the main processing of FIG. 11.

In the key input processing of FIG. 13, if it is determined that the key input does not correspond to the page turn-over operations, by means of the pressing of the arrow key either in the right or left position, e.g., NO at Step S35, CPU 10 then may determine whether the table-of-contents display operations are performed, at Step S37. For example, the user may give instructions for table-of-contents display operations by selecting and determining a “table-of-contents” button displayed on any screen, using operation keys 16. If the table-of-contents display operations are performed, e.g., YES at Step S37, CPU 10 may perform the above-described table-of-contents display processing of FIG. 12 at Step S38, and then may return to the main processing of FIG. 11.

In the key input processing of FIG. 13, if it is determined that the key input does not correspond to the table-of-contents display operations, e.g., NO at Step S37, CPU 10 may determine whether content request operations are performed, at Step S39. If the arrow key and the determination key are pressed concurrently, it may be deemed that instructions for content request operations are given. For example, if the arrow key and the determination key are pressed concurrently when a content, e.g., the body text of an article in the newspaper A, is being displayed, or when related content display screen 151 is being displayed, the operations may be regarded as content request operations.

Alternatively, a button that gives instructions for content request operations may be provided on a display screen of the body text of the article in the newspaper A, or on related content display screen 151. If content request operations are performed, e.g., YES at Step S39, CPU 10 may perform the content request processing Step S40, which will be described in further detail herein with respect to FIG. 17. The content request processing may be performed to display a list of the titles of the related articles of an article in the newspaper A, or to give a request to deliver, e.g., transmit, the full-text data of the body texts of the related articles.

Referring to FIG. 17, following the start of the content request processing, CPU 10 may determine whether related content display screen 151 is being displayed at Step S401. If related content display screen 151 is not being displayed, e.g., NO at S401, that is, if the body text of an article in the newspaper A is being displayed instead, CPU 10 may perform the related content list generation processing at Step S420, which will be described in further detail herein with respect to FIG. 18. In the related content list generation processing, a list of articles of any other companies relating to an article in the newspaper A, whose body text is being browsed by the user, may be generated and displayed.

Referring to FIG. 18, following the start of the related content list generation processing, CPU 10 may reference displayed-content storage area 121 of RAM 12. At this point, the displayed-content information read out from memory card 190 at Step S342 of the item determination processing shown in FIG. 15, may be stored in displayed-content storage area 121. The displayed-content information may comprise the article ID, the article title, and the full-text data of the body of an article in the newspaper A. CPU 10 may acquire index information including a main article ID that may match the article ID included in the displayed-content information from index information storage area 192 of memory card 190, and may store the acquired index information in related content storage area 122 of RAM 12, as related content information. Then, CPU 10 may generate a related content list, e.g., as shown in FIG. 7, in which the article ID included in the displayed-content information may be used as the main article ID, and the article ID of the related content information may be used as a related article ID. The generated list may be stored in related content list storage area 123 of RAM 12 at Step S421.

As shown in FIG. 3, in an example of an embodiment of the invention, the arrow key and the determination key may be pressed concurrently to perform the content request operations when the body text “Stock price of Company X . . . ” of an article in the newspaper A having an article ID “A101” is being displayed on display portion 15 This may correspond to YES at Step S39 in FIG. 13, and NO at Step S401 in FIG. 17. Further, the index information of the newspaper B shown in FIG. 4 and the index information of the newspaper C shown in FIG. 5 may be stored in index information storage area 192 of memory card 190 at this point.

In the example, the index information having a main article ID of “A101” and an article ID of “B103” may be obtained from the index information of the newspaper B, and may be stored into the related content storage area 122. In addition, the index information having a main article ID of “A101” and an article ID of “C118” also may be obtained from the index information of the newspaper C, and may be stored into related content storage area 122. Then, as shown in FIG. 7, the obtained “B103” and “C118” both may be associated with the main article ID “A101” and may be stored into related content list storage area 123 as a related content list, at Step S421 of FIG. 18. Further, for the article IDs stored in the related content list, the full-text necessity flags may be turned ON and stored in full-text necessity flag storage area 124 of RAM 12. In the example of FIG. 7, the full-text necessity flags corresponding to the main article ID “A101” and the related article IDs “B103” and “C118” may be turned ON and stored.

Referring to FIG. 18, CPU 10 then may display a list of the titles of the main article in the newspaper A whose body text has been displayed on display portion 15, the related articles in the newspapers B and C, and marked full-text necessity checkboxes 152, based on the generated related content list, at Step S422. Then, CPU 10 may return to the content request processing of FIG. 17, and then to the key input processing of FIG. 13, and further to the main processing of FIG. 11.

If at Step S401 of the content request processing of FIG. 17, it is determined that related content display screen 151 is being displayed, e.g., YES at Step S401, then instructions may be given to display the full texts of the bodies of the respective related articles by means of the content request operations. In the example illustrated in the drawings, user of browsing terminal 1 subscribes to the newspaper A, and therefore only the article IDs and the article titles of the related articles in the newspapers B and C may be delivered as the index information as shown in FIGS. 4 and 5.

In other words, the full-text data of the bodies of the related articles may not be stored in browsing terminal 1, and full-text display of the body texts of the related articles may not be provided. CPU 10 thus may perform processing described herein, in order to request server 3, which may store the full-text data of the bodies of the related articles in the newspapers B and C, to deliver, e.g., transmit, the full-text data.

CPU 10 first may delete the article ID for which the full-text necessity flag is stored as OFF in full-text necessity flag storage area 124 from the related content list stored in the related content list storage area 123, at Step S402. The article having the article ID for which the full-text necessity flag is OFF may correspond to the article for which the user cleared the mark of full-text necessity checkbox 152 shown in FIG. 22. For articles in which full-text necessity checkbox 152 is cleared, it may not be necessary to request the full-text data.

CPU 10 then may determine, at Step S403, whether browsing terminal 1 currently is connected to a network 110, e.g., the Internet, via LAN controller 17. The determination may be made at this point due to the possibility that processing may vary depending on whether browsing terminal 1 is currently connected to network 110. In particular, if browsing terminal 1 is connected to the network, browsing terminal 1 may perform processing for immediately requesting server 3 to deliver, e.g., transmit, the full-text data of the related articles. If browsing terminal 1 is not connected to the network 110, browsing terminal 1 may perform processing for preparing for requesting the full-text at a time at which connection may be established.

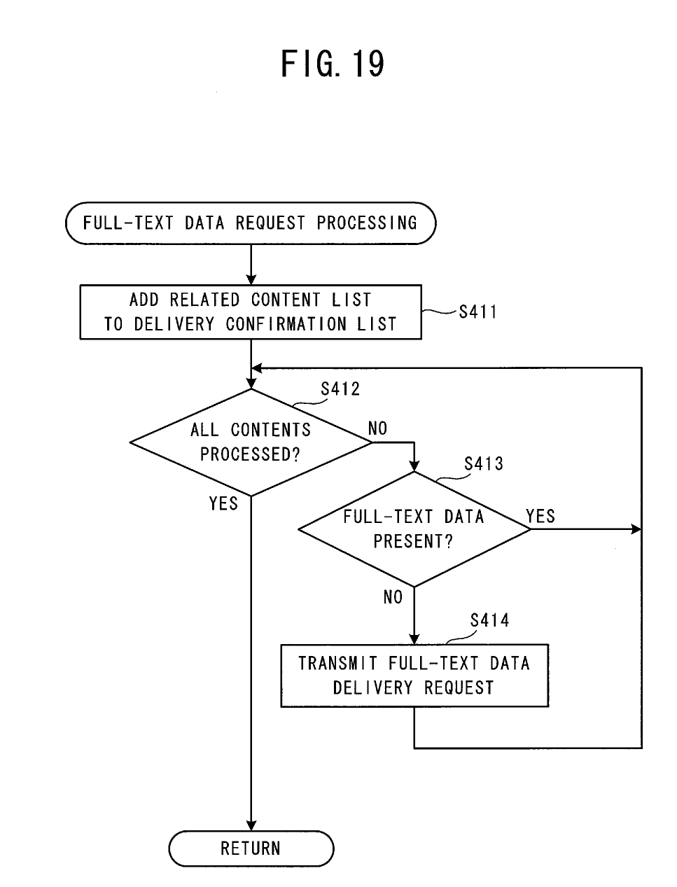

If browsing terminal 1 currently is connected to network 110, e.g., YES at Step S403, full-text data request processing may be performed to request the server 3 to deliver, e.g., transmit, the full-text data at Step S410, which may be described in further detail with respect to FIG. 19. As shown in FIG. 19, following the start of the full-text data request processing, CPU 10 may, at Step S411, add the related content list currently stored in the related content list storage area 123 to the delivery confirmation list, e.g., the delivery confirmation list shown in FIG. 9, which may be stored in delivery confirmation list storage area 126 of RAM 12. If the related content list of FIG. 7, for example, currently is stored in related content list storage area 123, a request ID of “P01” serving as an identification code may be given to the main article ID and the related article IDs “A101”, “B103” and “C118” as one related content list, as shown in FIG. 9.

Further, for each of the article IDs, presence or absence of the full-text data, represented in FIG. 9 by “YES” and “NO,” respectively, also may be stored, based on whether the full-text data of the body of the article is stored in content information storage area 191 of memory card 190. In an illustrative example, the user of browsing terminal 1 subscribes to the newspaper A, and does not subscribe to newspapers B and C. As shown in FIG. 9, as the full-text data presence/absence corresponding to the article ID “A101”, “YES”, which may indicate the presence of the data, may be stored, whereas “NO”, which may indicate the absence of data, may be stored for “B103” and “C118.”

Then, CPU 10 may determine whether the processing has been completed on all of the contents stored in the delivery confirmation list at Step S412. If the processing has not been completed yet, e.g., NO at Step S412, CPU 10 may reference the delivery confirmation list to check for the presence or the absence of full-text data of the body text having an article ID first stored in the delivery confirmation list, at Step S413. As shown in the example of FIG. 9, content information storage area 191 stores full-text data of the body text of the article in the newspaper A having the article ID “A101,” e.g., YES at Step S413, CPU 10 may return to execute Step S412. In the example, the processing has not been completed on all the contents in the delivery confirmation list, e.g., NO at Step S412, and CPU 10 then may check for the presence or absence of full-text data on the next article ID of “B103” at Step S413.

In the example shown in FIG. 9, the full-text data of the related article in the newspaper B having the article ID “B103” may not be stored in content information storage area 191, e.g., NO at Step S413. CPU 10 then may transmit a delivery request to server 3 that may request delivery of the full-text data of the body of the article corresponding to the article ID “B103” to browsing terminal 1 at Step S414. Similarly, CPU 10 may repeat the processing in Steps S412 through S414 to transmit a delivery request to server 3 for the article IDs, which may be stored in the delivery confirmation list as having no full-text data, e.g., NO at Step S413, until all the contents of the delivery confirmation list have been processed, e.g., YES at Step S412. When all the contents of the delivery confirmation list have been processed, CPU 10 may return to the content request processing shown in FIG. 17. Then, at Step S406, CPU 10 may display, on display portion 15, a screen that had been displayed before related content display screen 151 was displayed, and then CPU 10 may return to the key input processing of FIG. 13, and further to the main processing of FIG. 11.

If it is determined at Step S403 of the content request processing of FIG. 17 that browsing terminal 1 is not currently connected to the network, e.g., NO at Step S403, browsing terminal 1 may not immediately request server 3 to deliver, e.g., transmit, the full-text data. In this case, at Step S405, CPU 10 may add the related content list currently stored in related content list storage area 123 to the request waiting list, e.g., the request waiting list illustrated in FIG. 8, which may be stored in request waiting list storage area 125. In the example of the related content list shown in FIG. 7, the main article ID and the related article IDs “A101”, “B103” and “C118” as one related content list may be added to the request waiting list, and a request ID “PW01” serving as an identification code may be assigned to the related content list. As shown in FIG. 8, if the content request operations are performed a plurality of times while browsing terminal 1 is not connected to the network, a plurality of related content lists may be stored in the request waiting list. Referring again to FIG. 17, at Step S406, CPU 10 may display, on display portion 15, a screen that had been displayed before related content display screen 151, and then CPU 10 may return to the key input processing of FIG. 13, and further to the main processing of FIG. 11.

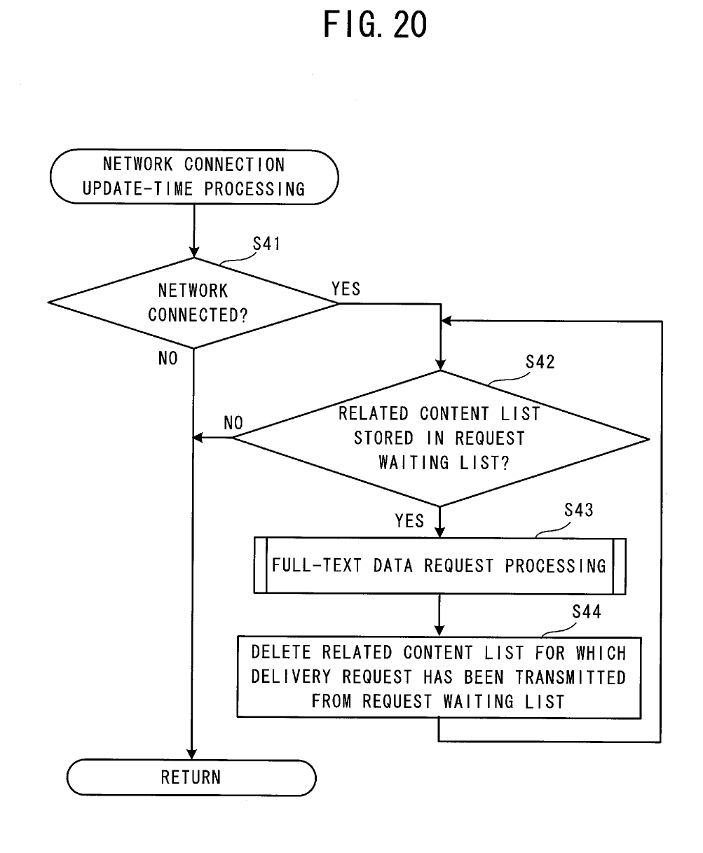

If the key input processing, e.g., the processing described in FIGS. 13-19, has been completed, then in the main processing of FIG. 11, CPU 10 may determine whether network connection information is updated, that is, whether the disconnected network is newly connected, or the connected network is newly disconnected, at Step S4 of FIG. 11. If it is determined that the network connection information is updated, e.g., YES at Step S4, CPU 10 may perform network connection update-time processing at Step S5, described in more detail herein with respect to FIG. 20. In the network connection update-time processing, if the disconnected network is newly connected, CPU 10 may request server 3 to deliver, e.g., transmit, the full-text data of the body text of a related article based on the above-described request waiting list stored beforehand.

Referring now to FIG. 20, following the start of the network connection update-time processing, CPU 10 may, at Step S41, determine whether the updated information indicates that the disconnected network is newly connected. If it is determined that the network is disconnected, e.g., NO at Step S41, CPU 10 may return to the main processing of FIG. 11. If it is determined that the disconnected network is newly connected, e.g., YES at Step S41, CPU 10 may determine whether a related content list is stored in the request waiting list at Step S42. If browsing terminal 1 is not connected to the network, e.g., NO at Step S403 of FIG. 17, when the user performs the content request operations to instruct full-text display of the body text of the article, e.g., YES at Step S401 of FIG. 17, the related content list for requesting the full-text data may be added to the request waiting list at Step S405 of FIG. 17. If it is determined that the related content list is stored in the request waiting list, e.g., YES at Step S42, CPU 10 may perform the full-text data request processing at S43, and described in further detail with respect to FIG. 19.

Following the start of the full-text data request processing of FIG. 19, CPU 10 may, at Step S411, add the related content list in the request waiting list, e.g., the request waiting list shown in FIG. 8, to the delivery confirmation list, e.g., the delivery confirmation list shown in FIG. 9, stored in delivery confirmation list storage area 126 of RAM 12. If the request waiting list including a plurality of related content lists is stored, as shown in FIG. 8, the delivery confirmation list also may include the plurality of related content lists, as shown in FIG. 9. Further, based on whether the full-text data of the body text of the article is stored in content information storage area 191, the full-text data presence, e.g., YES in the “Full-Text Data Presence/Absence” column of FIG. 9, or absence, e.g., NO in the “Full-Text Data Presence/Absence” column of FIG. 9 may be stored for each of the article IDs as well. The subsequent processing in Steps S412 to Steps S414 in the full-text data request processing may be the same processing as that of Step S410 in the content request processing shown in FIG. 17, and the detailed description of that processing is omitted here.

Referring again to FIG. 20, after the full-text data request processing has been completed at Step S43, CPU 10 may delete the related content list for which the delivery request has been completed, from the request waiting list stored in the request waiting list storage area 125, at Step S44. Then, CPU 10 may return to Step S42 to repeat the above-described processing of Steps S42-S44. In the example of the request waiting list shown in FIG. 8, among the article IDs “A101”, “B103”, and “C118” in the related content list having the request ID “PW01”, the delivery requests for the full-text may be transmitted for the article IDs “B103” and “C118” which many not have full-text data, e.g., “NO” in the Full-Text Data Presence/Absence” column of the P01 Row of FIG. 9 in the first round of the processing occurring at Step S43 of FIG. 20. Subsequently, the related content list having request ID “PW01” may be deleted from the request waiting list at Step S44. Then, among the article IDs included in the related content list with the remaining request ID “PW02”, CPU 10, in the second round of the processing at Step S43, may transmit delivery requests for the articles having article IDs “B104”, “C128” and “C068” having no full-text data. Subsequently, the related content list with the request ID “PW02” may be deleted at Step S44. As a result, at Step S42, there may be no related content list remaining in the request waiting list, e.g., NO at Step S42, CPU 10 then may return to the main processing of FIG. 11.

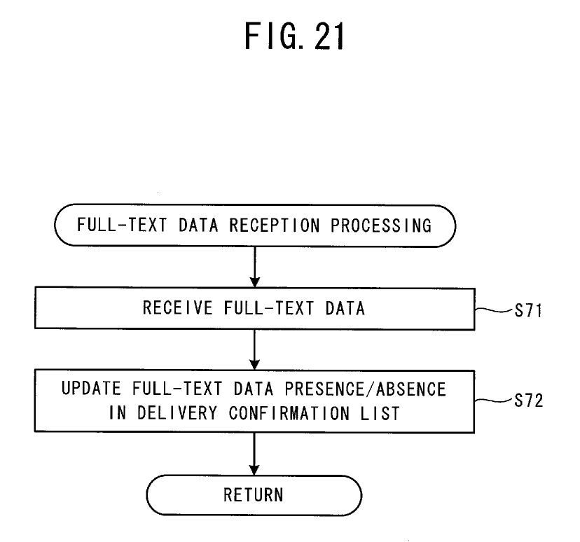

Referring again to FIG. 11, after the network connection update-time processing is performed as described above in Step S5, or if the network connection information is not updated e.g., NO at Step S4) in the main processing of FIG. 11, CPU 10 may determine whether the full-text data transmitted from server 3 is received in response to the delivery request at Step S6. If it is determined that the full-text data is received, e.g., YES at Step S6, CPU 10 may perform full-text data reception processing at Step S7, and described in further detail herein with respect to FIG. 21.

Referring to FIG. 21, at Step S71, CPU 10 may receive the full-text data of the body text of an article, an article ID, and an article title that server 3 may deliver, e.g., transmit. CPU 10 may store the received data as the content information in content information storage area 191 of memory card 190. Then, CPU 10 may update the full-text data presence or absence corresponding to the received article ID in the delivery confirmation list stored in the delivery confirmation list storage area 126 at Step S72, and then may return to the main processing of FIG. 11. For example, if the delivery waiting list of FIG. 9 is stored, and if the full-text data with the article IDs “B103” and “C118” is received, the full-text data presence or absence corresponding to the article IDs “B103” and “C118” may be updated to “YES” to indicate the presence of the full-text data.

Referring again to FIG. 11, after the full-text data reception processing at Step S7 is performed, or if the full-text data is not received, e.g., NO at Step S6, at Step S8, CPU 10 may determine whether the full-text data reception has been completed on all the articles in the related content list for which server 3 has been requested to deliver, e.g., transmit, the full-text data. If CPU 10 determines that the full-text data has already been received for all the articles, e.g., YES at Step S8, CPU 10 may delete the related content list having the complete full-text data received from the delivery confirmation list at Step S9. For example, in the delivery confirmation list of FIG. 9, if the full-text data presence/absence column is “YES” for each of the article IDs “B103” and “C118” in the related content list having the request ID “P01” as described above, CPU 10 may determine that all the full-text data has been received, because the full-text data for the article having the article ID “A101” originally may be “YES”. Therefore, the related content list having the request ID “P01” may be deleted from the delivery confirmation list of FIG. 9.

After CPU 10 deletes the related content list with all the full-text data at Step S9, CPU 10 may substantially simultaneously display the body texts of the articles included in the related content list having all the full-text data on display portion 15 at Step S10. To display the body texts of all the articles, the content information of a main article in the newspaper A and the related articles in the newspapers B and C may be inserted into a template, which may be separately prepared beforehand. In this manner, each of the articles may be displayed page by page in the same format and layout, for example. By providing such uniform display, the user of browsing terminal 1 easily may compare the related articles in different newspapers while reading. After the body texts of the articles are displayed at Step S10, or CPU 10 determines that the full-text data is not received, e.g., NO at Step S8, CPU 10 may returns to Step S2 to repeat the above-described processing of S3-S10, until the power is turned OFF, e.g., YES at Step S2.

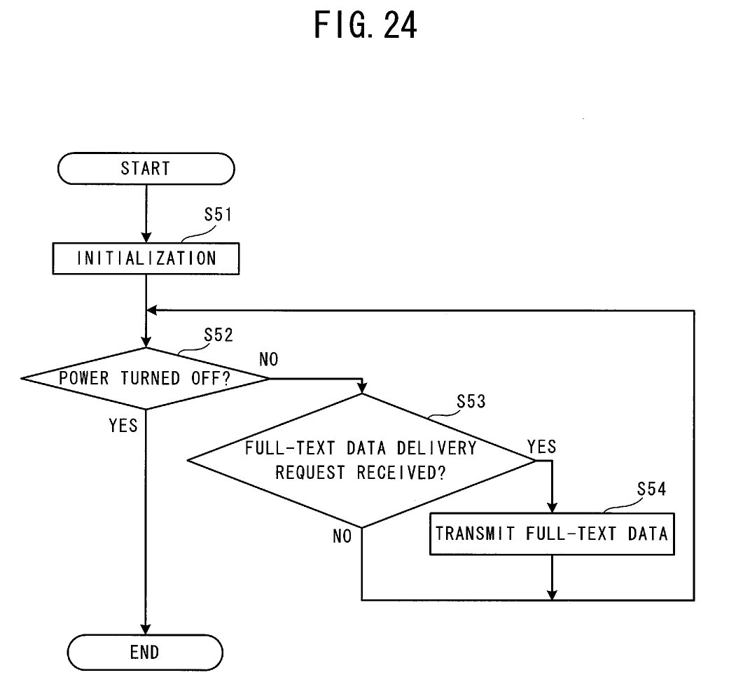

FIG. 24 describes processing performed by server 3 according to an embodiment of the invention. The main processing involves transmitting full-text data to browsing terminal 1 in response to a delivery request for the full-text data of the body text of an article received from browsing terminal 1. The main processing may be performed by CPU 30 in accordance with the programs stored in the ROM 31.

As shown in FIG. 24, when the power of server 3 is turned ON to start the main processing, CPU 30 may perform initialization, e.g., clearing each of the storage areas of RAM 32, at Step S51. If the power is turned OFF after the initialization, e.g., YES at Step S52, CPU 30 may terminate the main processing shown in FIG. 24. Nevertheless, while the power is not turned OFF, e.g., NO at Step S52, CPU 30 may repeat processing of Steps S53 through S54 as described herein.

CPU 30 first may determine, at Step S53, whether a full-text data delivery request is received from browsing terminal 1. If the user of browsing terminal 1 has instructed full-text display of the body texts of the related articles in the newspapers B and C relating to an article in the newspaper A, a delivery request may be transmitted from browsing terminal 1 to server 3. If server 3 receives the delivery request, e.g., YES at Step S53, server 3 may read out the content information, e.g., the article ID, article title, and full-text data of the body of the article. This content information may correspond to the article IDs that respectively agree with the article IDs of the newspapers B and C included in the delivery request from the article DB, e.g., the article DB of FIG. 10 which may be stored in article DB storage area 341 in RAM 32, Server 3 then may transmit the read out data to browsing terminal 1 at Step S54. As described above, the article DB accumulates the content information of all of the newspaper articles acquired from article servers 301, 302, and 303, of each of the newspaper companies that publish newspapers A, B, and C, respectively. When server 3 has transmitted the full-text data to browsing terminal 1 in response to the delivery request at Step S54, CPU 30 may return to Step S52, and may repeat the processing of Steps S53 through S54 until power is turned OFF, e.g., YES at Step S52.

In an embodiment of the invention, although the full-text data of the body texts of the articles in the newspaper A, which the user may subscribe to in an example, regularly may be delivered from server 3 to browsing terminal 1, the index information, and not the full text, of the related articles related to the articles in the newspaper A for reference may be delivered for other articles in other newspapers. If the user of browsing terminal 1 wishes to browse not only a main article in the newspaper A, but also the full body texts of the related articles in any other newspaper, the user may utilize the index information to display a list of the related articles, then to request server 3 to deliver, e.g., transmit, the full-text data of the related articles.

When server 3 receives the delivery request for the full-text data of the related articles, server 3 may select relevant data from among the article data accumulated in the article DB and may transmit the data to browsing terminal 1. When browsing terminal 1 receives the delivered data, the user may browse the full texts of the related articles on browsing terminal 1. Thus, the full-text data of the body text of an article additionally may be delivered as needed, such that the user easily may browse desired articles, without increasing an amount of data stored in browsing terminal 1. The user of browsing terminal 1 further may choose a desired content for which the full-text data is to be requested, based on the titles of the related articles displayed as the list, which also may reduce the amount of the full-text data to be delivered to browsing terminal 1. Further, the main article in the newspaper A and the related articles in any other newspapers may be displayed on browsing terminal 1 in a common format, which may facilitate a comparison of articles of different newspapers while a user is reading articles of different newspapers.

Moreover, according to browsing terminal 1 of the present embodiment, if content request operations are performed while browsing terminal 1 is not connected to server 3, a request waiting list may be created, such that the delivery request may be transmitted automatically when browsing terminal 1 and server 3 are connected to each other at a later time. Therefore, the user may instruct delivery of the related articles independently of the status of a connection between browsing terminal 1 and server 3.

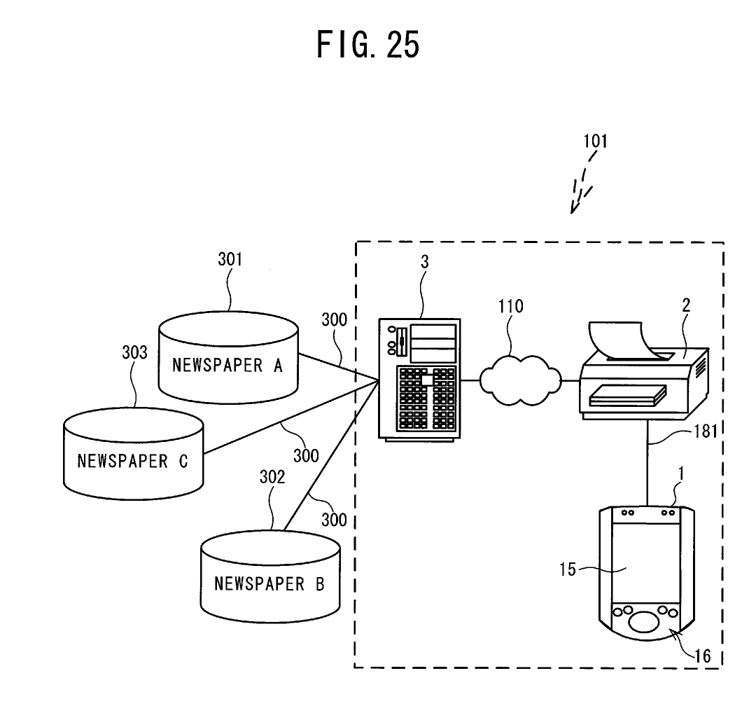

Another embodiment of the invention is described herein with reference to FIGS. 25-41. As shown in FIG. 25, content delivery system 101 according to another embodiment of the invention may be different from the above-described content delivery system 100 shown in FIG. 1. Specifically, content delivery system 101 may comprise a printer 2, in addition to browsing terminal 1 and server 3. In content delivery system 101, browsing terminal 1 may be connected to printer 2 via a connecting cable, e.g., USB cable 181. Server 3 and printer 2 also may be connected via a network 110, e.g., the Internet.

In another embodiment of the invention, content information first may be transmitted from server 3 to printer 2, and further transferred to browsing terminal 1. In response to operations by the user, a list, e.g., a related content list about newspaper articles, of contents that may be desired to be browsed or printed may be transmitted from browsing terminal 1 to printer 2 through USB cable 181. The user of browsing terminal 1 may specify an output destination of the contents. When printer 2 receives the list, printer 2 may request server 3 to deliver, e.g., transmit, the data of the contents included in the list to printer 2, and further may receive the data transmitted from server 3 in response to the request. Further, if the specified output destination is browsing terminal 1, printer 2 may transfer the received data to browsing terminal 1. In addition, if the output destination is printer 2, printer 2 may print information based on the received data. In content delivery system 101 browsing terminal 1 may make a delivery request to server 3 via printer 2. Further, by specifying an output destination of the contents, the user may choose whether the full-text data is to be delivered to browsing terminal 1 or to be printed with printer 2.

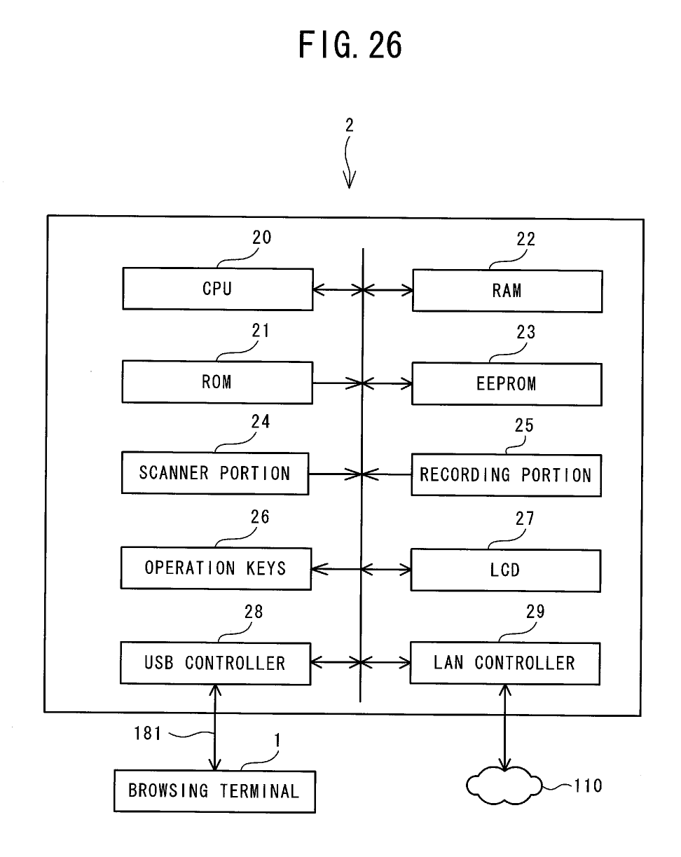

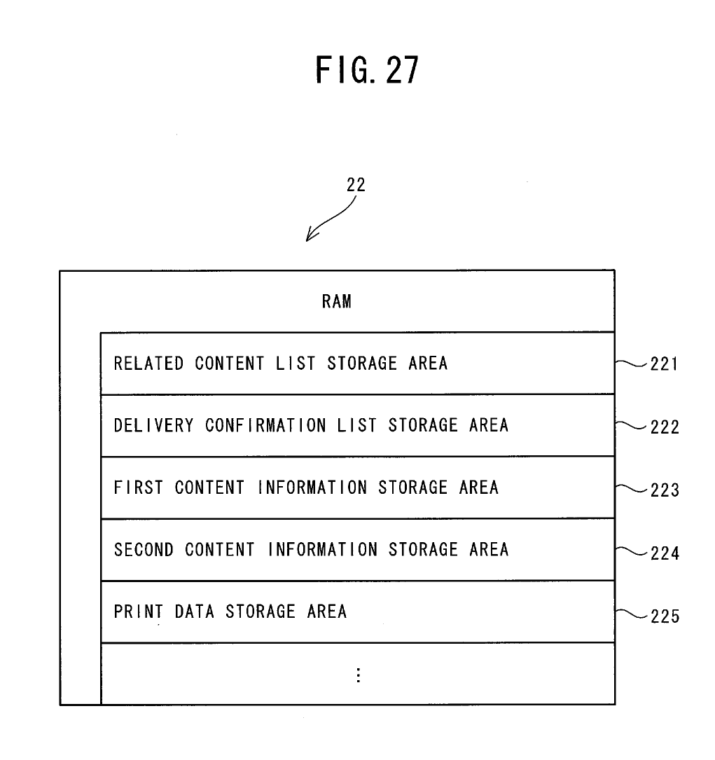

Browsing terminal 1 and the server 3 operate in a manner similar to the first embodiment, and a detailed description of their operations are omitted here. FIGS. 26 and 27 describe printer 2 according to another embodiment of the invention.

As shown in FIG. 26, printer 2 may comprise a CPU 20, a ROM 21, a RAM 22, an EEPROM 23, a scanner portion 24, a recording portion 25, operation keys 26, a liquid crystal display (“LCD”) 27, a USB controller 28, and a LAN controller 29, all of which may be connected to each other, e.g., via a bus. ROM 21 may store a variety of programs to be used to operate printer 2, and CPU 20 may control the operations of printer 2 in accordance with the programs stored in ROM 21. RAM 22 is described in further detail herein. The EEPROM 23, which may be a nonvolatile memory, may store an apparatus ID, which may be an identification code, e.g., to identify printer 2. Scanner portion 24 may function as a scanner to read data, e.g., image data. Recording portion 25 may function as a printer to print a content, which may be delivered from server 3. Operation keys 26 may be input means to accept inputs made by the user. LCD 27 may be a display that displays information inputted from operation keys 26. USB controller 28 may be used to transmit and receive data to and from any other device, e.g., browsing terminal 1 through USB communications, e.g., via USB cable 181. LAN controller 29 may be used to connect to any other external device, e.g., server 3. This connection may be made via a network 110, e.g., the Internet.

As shown in FIG. 27, RAM 22, which temporarily may store various kinds of data, may include a plurality of storage areas, e.g., a related content list storage area 221, a delivery confirmation list storage area 222, a first content information storage area 223, a second content information storage area 224, and a print data storage area 225. Related content list storage area 221 may store a related content list generated by browsing terminal 1 and transmitted to printer 2. Delivery confirmation list storage area 222 may store a delivery confirmation list that may be used to confirm presence or absence of the full-text data for each of the contents, e.g., articles, in a related content list transmitted from browsing terminal 1. First content information storage area 223 may store the content information of articles transmitted from browsing terminal 1 together with the related content list. Second content information storage area 224 may store the content information of articles delivered from server 3, in response to a full-text data delivery request from printer 2. Print data storage area 225 may store the print data of contents, e.g., articles to be printed.

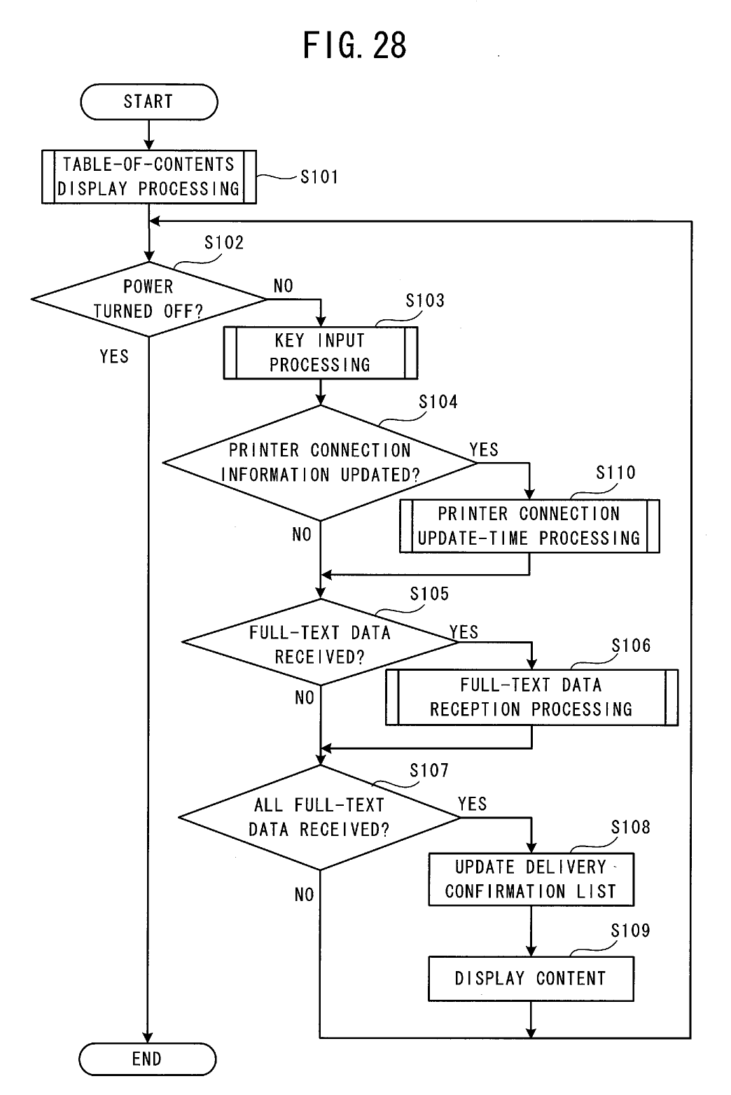

FIGS. 28-40 describe content delivery system 101 processing. FIGS. 28-35 describe browsing terminal 1 processing according to another embodiment of the invention. Browsing terminal 1 of the present embodiment may transmit a related content list, which may include a main article in the newspaper A and the related articles to printer 2. Browsing terminal 1 also may request printer 2 to output data to a specified output destination. The processing shown in FIGS. 28-32 may be performed by CPU 10 in accordance with the programs stored in ROM 11.

When the power of browsing terminal 1 is turned ON to start main processing of FIG. 28, CPU 10 may perform table-of-contents display processing at Step S101. The table-of-contents display processing is the same as in the previous embodiment, as shown in FIG. 12, and the detailed operations are omitted here. If the power is turned OFF after the table-of-contents screen is displayed, e.g., YES at Step S102, CPU 10 may terminate the main processing shown in FIG. 28. Nevertheless, while the power is not turned OFF, e.g., NO at Step S102, CPU 10 may repeat processing of Steps S103-S110, which will be described in further detail herein.

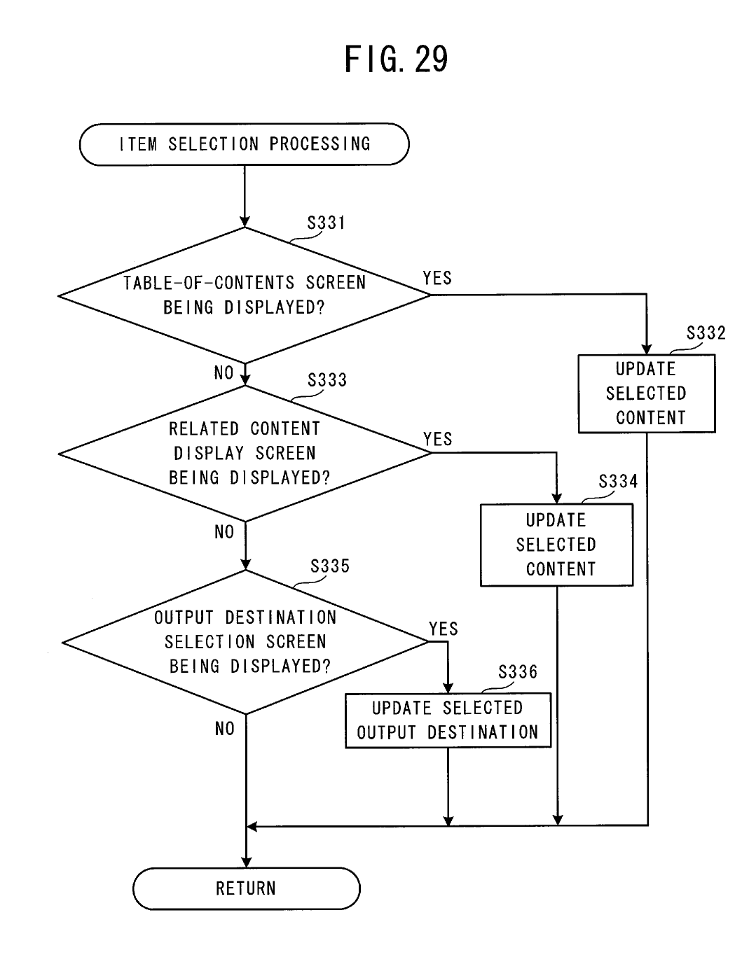

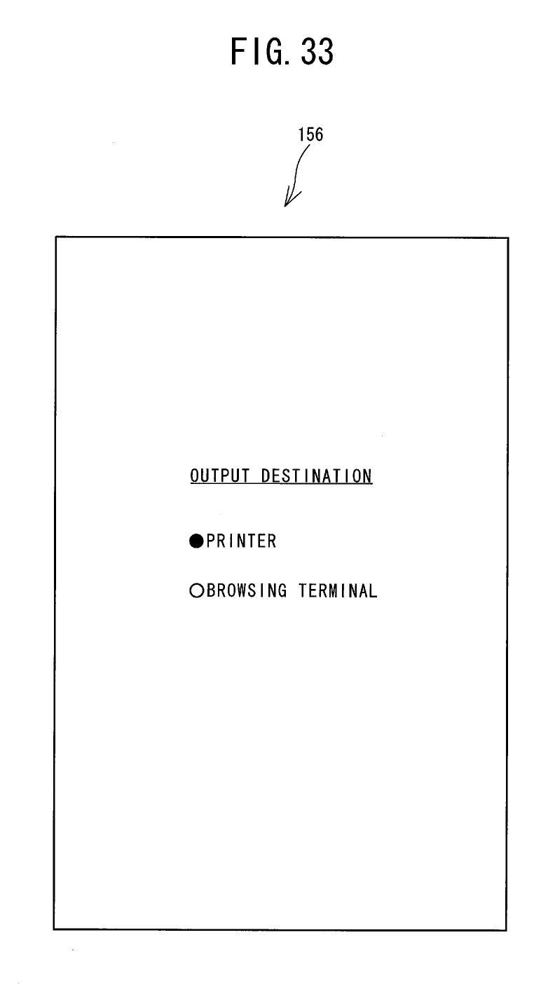

First, at Step S103, CPU 10 may perform key input processing. The key input processing of the present embodiment may be different than the key input processing shown in FIG. 13. Specifically, item selection processing at Step S32, the item determination processing at Step S34, and the content request processing at Step S40 may be different than in the above embodiment. Therefore, the other steps related to key input processing are omitted. Following the start of the key input processing, as shown in FIG. 13, if the item selection operations are performed by pressing the arrow key either in the upper or lower position, e.g., YES at Step S31, the item selection processing may be performed at Step S32. As shown in FIG. 29, if a table-of-contents screen or related content display screen 151 is being displayed, e.g., YES at Step S331 or YES at Step S333, CPU 10 may update the selected content as in the case of the previous embodiment. If neither the table-of-contents display screen nor the related content display screen is being displayed, e.g., NO at Step S331, NO at Step S333, CPU 10 may determine whether an output destination selection screen 156 is being displayed at Step S335. Output destination selection screen 156 may be prepared as shown in FIG. 33.

When the user wishes to compare an article in the newspaper A and the related articles in any other newspapers to each other while reading, the user may select whether to browse the articles on browsing terminal 1, or to print the articles with printer 2 via output destination selection screen 156. Therefore, if the output destination selection screen 156 is being displayed, e.g., YES at Step S335, CPU 10 may, at Step S336, update the highlight-displayed output destination, e.g., printer 2 or browsing terminal 1 in response to the operations of the arrow key. Then, CPU 10 may return to the key input processing of FIG. 13, then to the main processing of FIG. 28. Further, if the output destination selection screen 156 also is not being displayed, e.g., NO at Step S335, the key input operations may be deemed invalid, and CPU 10 may return to the key input processing of FIG. 13.

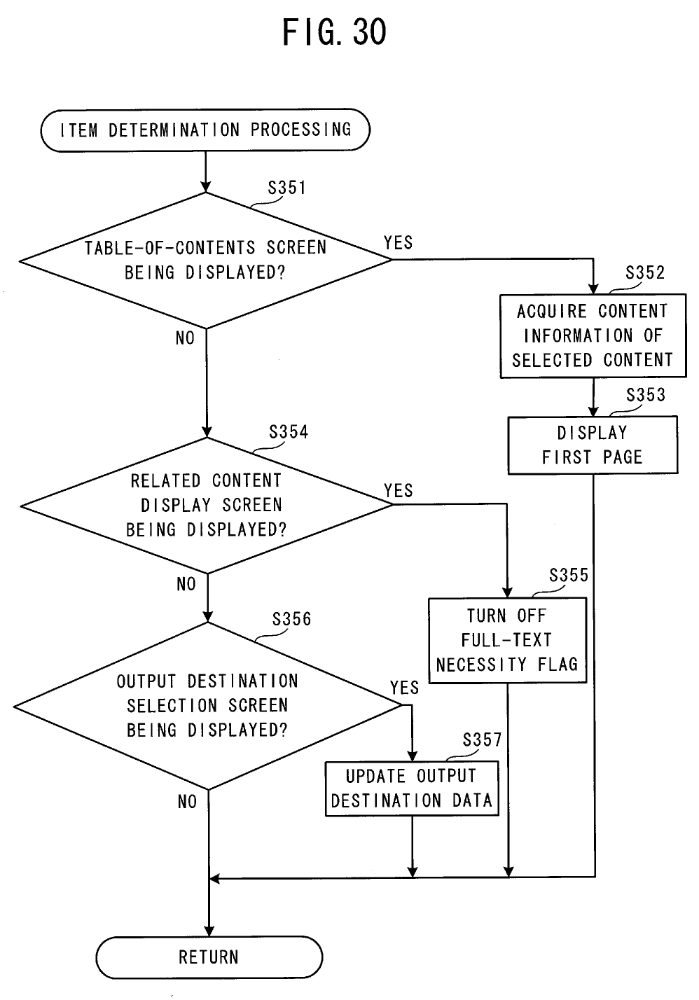

Next, if the item determination operations are performed by pressing the determination key in the key input processing of FIG. 13, e.g., YES at Step S33, item determination processing may be performed at Step S34. As shown in FIG. 30, if the table-of-index screen is being displayed, e.g., YES at Step S351, CPU 10 may read out the content information of the selected content from the memory card 190, similarly to the previous embodiment, at Step S352, and then may display a first page at Step S353. If the item determination operations are performed while the related content display screen 151 is being displayed instead of the table-of-contents screen, e.g., NO at Step S351, and YES at Step S354, the full-text necessity flag for the selected content may be set OFF in Step S355.

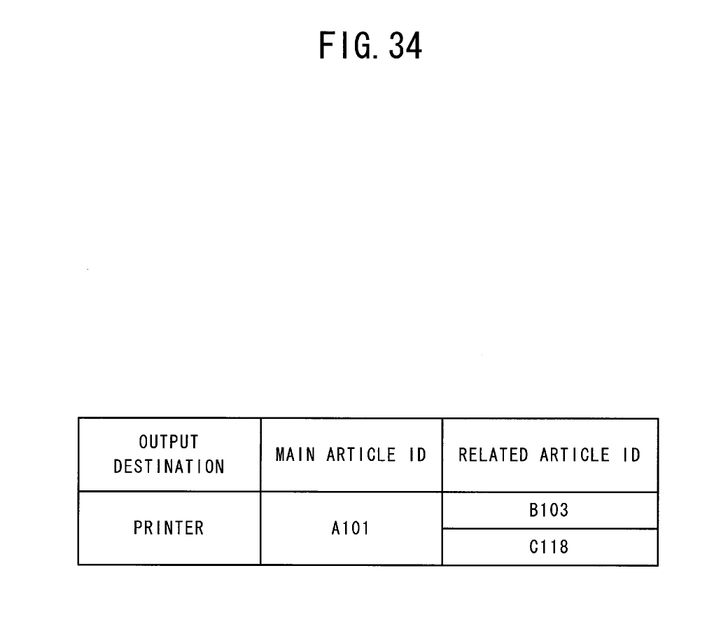

If the item determination operations are not performed while the table-of-contents display screen is being displayed or while related content display screen 151 is being displayed, e.g., NO at Step S351, and NO at Step S354, CPU 10 may determine whether the output destination selection screen 156 described above with respect to FIG. 33 may be displayed at Step S356. If the output destination selection screen 156 is being displayed, e.g., YES at Step S356, CPU 10 may update the data of output destination in a related content list stored in related content list storage area 123 at Step S357. As shown in FIG. 34, the related content list of the present embodiment may include data of the output destination, as well as the main article ID and the related article IDs included in the related content list, as in the previous embodiment.

In the previous embodiment, the full-text data may be delivered to browsing terminal 1, and the data of the output destination may not be needed. In the present embodiment, however, the output destination may be specified, depending on whether the user wishes to browse the articles on browsing terminal 1, or to print the articles. The information on the output destination also may be stored in the related content list. Referring again to FIG. 34, after the output destination for the related content list is updated at Step S357, CPU 10 may return to the key input processing of FIG. 13, and then to the main processing of FIG. 28. Further, if the output destination selection screen 156 also is not being displayed, e.g., NO at Step S356, the key input operations may be deemed invalid, and CPU 10 may return to the key input processing of FIG. 13.

If page turn-over operations are performed by pressing the arrow key in the right or left position in the key input processing of FIG. 13, e.g., YES at S35, the page turn-over processing, e.g., Step S36 of FIG. 16, may be performed. If the table-of-contents display operations are performed, e.g., YES at S37, the table-of-contents display processing, e.g., Step S38 of FIG. 12 may be performed. Because the page turn-over processing and the table-of-contents display processing is the same as in the previous embodiment, a detailed explanation is omitted here.

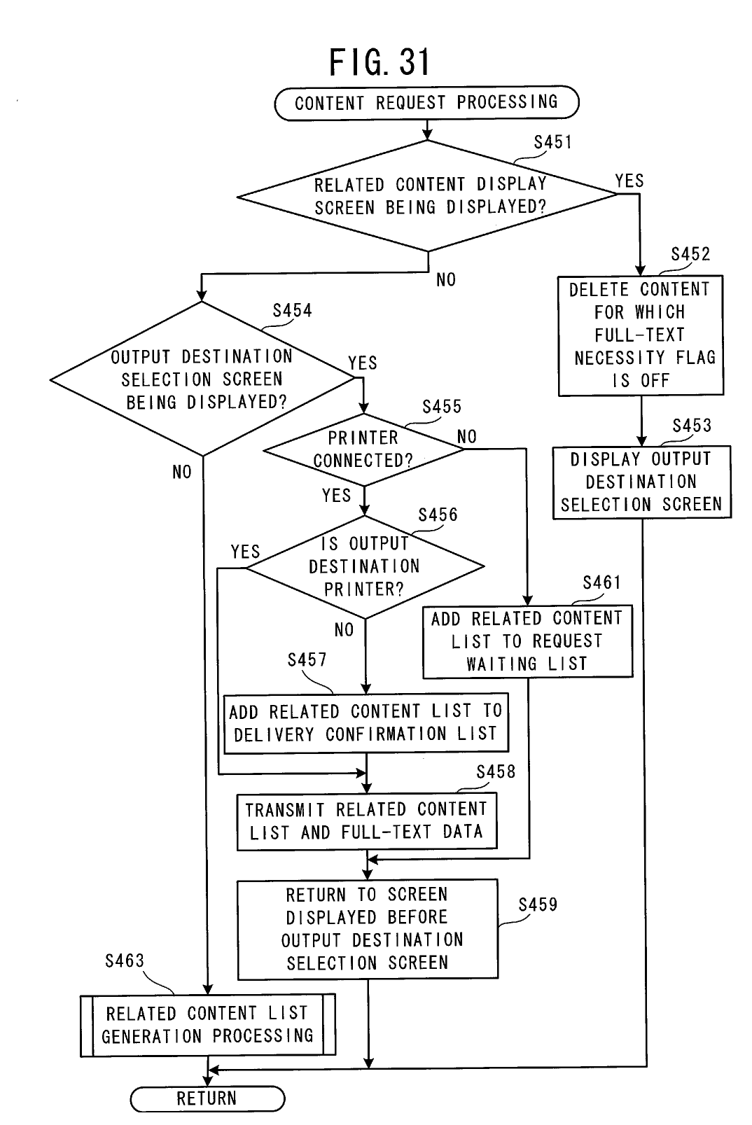

In the key input processing of FIG. 13, if the content request operations are performed, e.g., YES at Step S39, the content request processing may be performed at Step S40. Referring to FIG. 31, during content request processing, if the related content display screen 151 is being displayed, e.g., YES at Step S451, then CPU 10 may delete the article ID for which the full-text necessity flag is set OFF from the related content list in Step S452. Then, CPU 10 may display the above-described output destination selection screen 156, as shown in FIG. 33, on the display portion 15, such that the user may select an output destination, and then may return to the key input processing of FIG. 13, and further may return to the main processing of FIG. 28.

While output destination selection screen 156 is displayed, if the content request operations are performed by the user again, e.g., NO at Step S451, and YES at Step S454, CPU 10 may determine whether browsing terminal 1 currently is connected to printer 2 via USB cable 181, at Step S455. If browsing terminal 1 is connected to printer 2, e, YES at Step S455, CPU 10 then may request server 3 to deliver, e.g., transmit, the full-text data by way of printer 2. If the output destination is printer 2, e.g., YES at Step S456, then, in Step S458, CPU 10 may transmits to printer 2 a related content list, e.g., the related content list shown in FIG. 34.

Also in Step S458, CPU 10 may transmit the content information of the article in the related content list, for which the full-text data of the body text is stored in browsing terminal 1. Referring to the example related content list shown in FIG. 34, the article ID “A101” is of an article in the newspaper A, therefore, content information, e.g., article ID, article title, and full-text data of the body, may be is stored in content information storage area 191 of memory card 190. Therefore, the content information may be read out and transmitted to printer 2 together with the related content list, e.g., the related content list of FIG. 34.

If the output destination is browsing terminal 1, e.g., NO at Step S456, CPU 10 may confirm a reception of the full-text data to be transmitted in response to the request. To carry out confirmation, at Step S457, CPU 10 may add a related content list currently stored in related content list storage area 123 to the delivery confirmation list, e.g., the delivery confirmation list shown in FIG. 9, which may be stored in delivery confirmation list storage area 126 of RAM 12. Because browsing terminal 1 may be set as the output destination, the output destination may be omitted from the delivery confirmation list, unlike the related content list. Further, for each of the article IDs, CPU 10 may refer to content information storage area 191, and may store the presence or absence of the full-text data, based on whether the full-text data of the body of the article is stored. CPU 10 then may transmit to printer 2 the related content list, e.g., the related content list of FIG. 34, to the output destination, and the content information of the article in the related content list for which the full-text data of the body may be stored in browsing terminal 1 at Step S458.

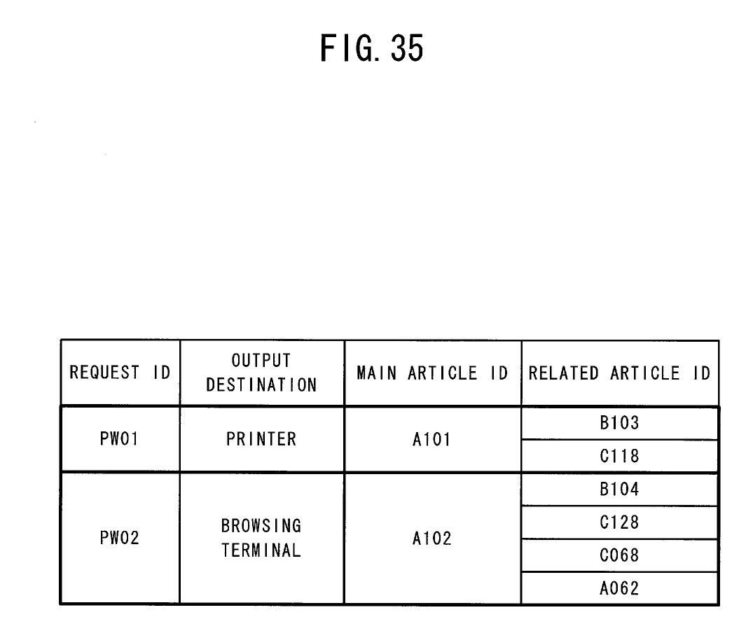

If browsing terminal 1 is not connected to printer 2 e.g., NO at Step S455, CPU 10 may add the related content list to a request waiting list stored in the request waiting list storage area 125 of RAM 12, such that the list may be transmitted to printer 2 when browsing terminal 1 and printer 2 are connected at a later time, e.g., at Step S461. In an embodiment, the data about the output destination, which may be included in the related content list, e.g., as shown in FIG. 34, also may be stored in the request waiting list. As shown in FIG. 35, the request waiting list may comprise a request ID, an output destination, a main article ID, and a related article ID. After the processing of Steps S458 or S461, CPU 10 may, at Step S459, display a screen on display portion 15 that was displayed before the output destination selection screen 156, and then may return to the key input processing of FIG. 13 and further to the main processing of FIG. 28.

If neither related content display screen 151 nor output destination selection screen 156 are displayed while the content request operations are performed, e.g., NO at Step S451, NO at Step S454, that is, when the body text of an article in the newspaper A may be displayed, CPU 10 may perform the related content list generation processing at Step S463. Since the related content list generation processing has a similar flow to the previous embodiment, only processes which are substantially the same as in the previous embodiment may be omitted. Referring to FIG. 18, at Step S421, a related content list, which may comprise an output destination, a main article ID, and a related article ID, e.g., as shown in FIG. 34, may be generated. A preset default output destination, e.g., printer 2 may be stored as the output destination at Step S421. In an embodiment of the invention, output destination selection screen 156 may appear with the checkbox corresponding to printer 2 being selected, e.g., the checkbox may be marked.

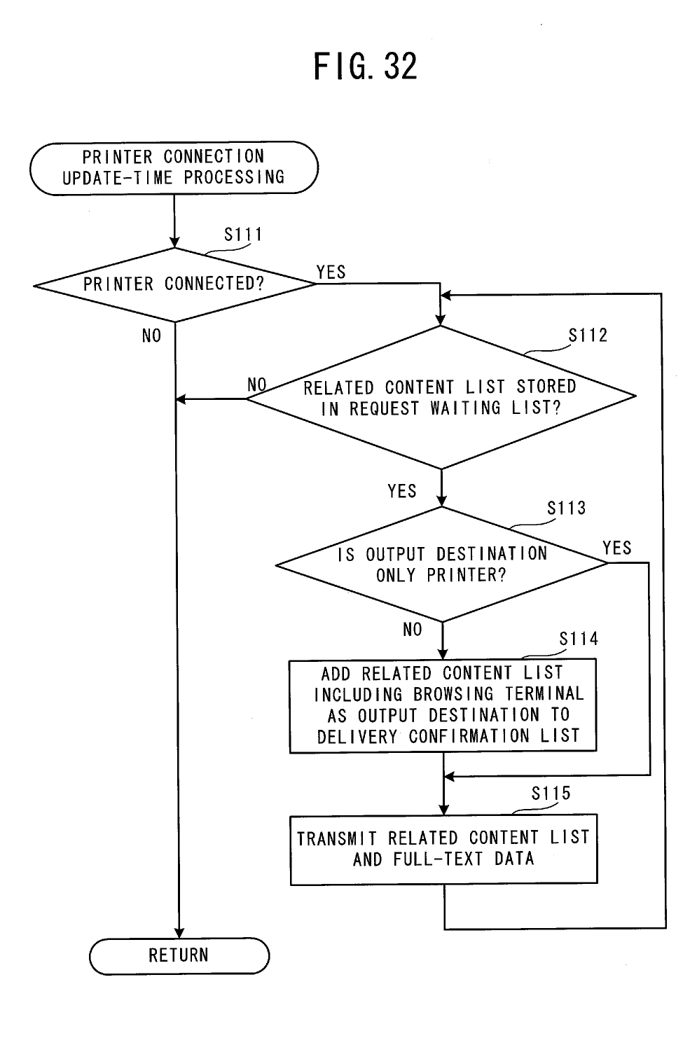

After the key input processing, e.g., the key input processing of FIG. 13, is completed in the main processing, e.g., Step S103 in FIG. 13, CPU 10 may determine whether the printer connection information is updated. CPU 10, at Step S104, may determine whether the unconnected printer 2 is newly connected via USB cable 181, or if the connected printer 2 is newly disconnected. If CPU 10 determines that the printer connection information is updated, e.g., YES at S104, CPU 10 may perform the printer connection update-time processing at Step S110, which is described in further detail with respect to FIG. 32. In the printer connection update-time processing, a related content list may be transmitted to printer 2, based on a request waiting list stored beforehand, if unconnected printer 2 is newly connected.

Following the start of the printer connection update-time processing shown in FIG. 32, CPU 10 may determine whether the updated information indicates that the unconnected printer 2 is newly connected at Step S111. If it is determined that printer 2 is disconnected, e.g., not connected, e.g., NO at Step S111, CPU 10 may return to the main processing of FIG. 28. If printer 2 is newly connected, e.g., YES at Step S111, CPU 10 may determine whether a related content list is stored in the request waiting list, e.g., the request waiting list shown in FIG. 35, which may be stored in request waiting list storage area 125 at Step S112. If the related content list is not stored in the request waiting list, e.g., NO at Step S112, CPU 10 may return to the main processing of FIG. 28.

If CPU 10 determines that a related content list is stored in the request waiting list, e.g., YES at Step S112, CPU 10 may determine, at Step S113, whether the printer 2 is stored as the output destination in the related content list currently stored in the request waiting list. If any related content list having browsing terminal 1 as the output destination is included in the request waiting list, e.g., NO at Step S113, CPU 10 may add the related content list having browsing terminal 1 as the output destination to the delivery confirmation list at Step S114, such that the reception of the full-text data to be transmitted later may be confirmed.

In the example shown using the request waiting list shown in FIG. 35, a related content list, which may include the request ID “PW02” may be added to the delivery confirmation list. Then, CPU 10 may transmit, at Step S115, the related content list stored in the request waiting list and the content information of the article in the related content list, for which the full-text data of the body is present in browsing terminal 1, to printer 2. If printer 2 is included as the only output destination in the related content list, e.g., YES at S113, CPU 10 may not add the related content list to the delivery confirmation list, but instead may transmit, at Step S115, the related content list and the content information of the article in the related content list for which the full-text data of the body is present, to printer 2. Then, CPU 10 may return processing to Step S112 to repeat the processing of Steps S113 to S115, until there are no more related content lists stored in the request waiting list, e.g., NO at Step S112. CPU 10 then may return to the main processing of FIG. 28.

In the main processing of FIG. 28, after the printer connection update-time processing at Step S110 is completed, or if it is determined that the printer connection information is not updated, e.g., NO at Step S104, CPU 10 may determine whether the full-text data is received from printer 2 at Step S105. Browsing terminal 1 may receive the full-text data when browsing terminal 1 is specified as the output destination. If the full-text data is received, e.g., YES at Step S105, the full-text data reception processing may be performed at Step S106. The full-text data reception processing may have the same flow as shown in FIG. 21, except that the full-text data may be transmitted by printer 2. Accordingly, the detailed explanation is omitted here.

After the full-text data reception processing has been completed at Step S106, or if the full-text data is not received, e.g., NO at Step S105, CPU 10 may determine whether the full-text data has been received for all of the articles in the related content list for which delivery of the full-text data was requested by way of printer 2, based on the full-text data presence/absence in the delivery confirmation list, at Step S107. If CPU 10 determines that the full-text data has been received for all the articles, e.g., YES at Step S107, CPU 10 may delete the related content list having the full-text data received from the delivery confirmation list, thereby updating the delivery confirmation list at Step S108.

Then, as in the previous embodiment, the content information of a main article in the newspaper A and the related articles in the newspapers B and C may be inserted into a template separately stored beforehand, and each of the articles may be displayed on display portion 15, page by page, and may be displayed in the same format and layout. After the body texts of the articles are displayed at Step S109, or if it is determined that not all of the full-text data has been received yet, e.g., NO at Step S107, CPU 10 may return to Step S102 to repeat the above-described processing, until the power is turned OFF, e.g., YES at Step S102.

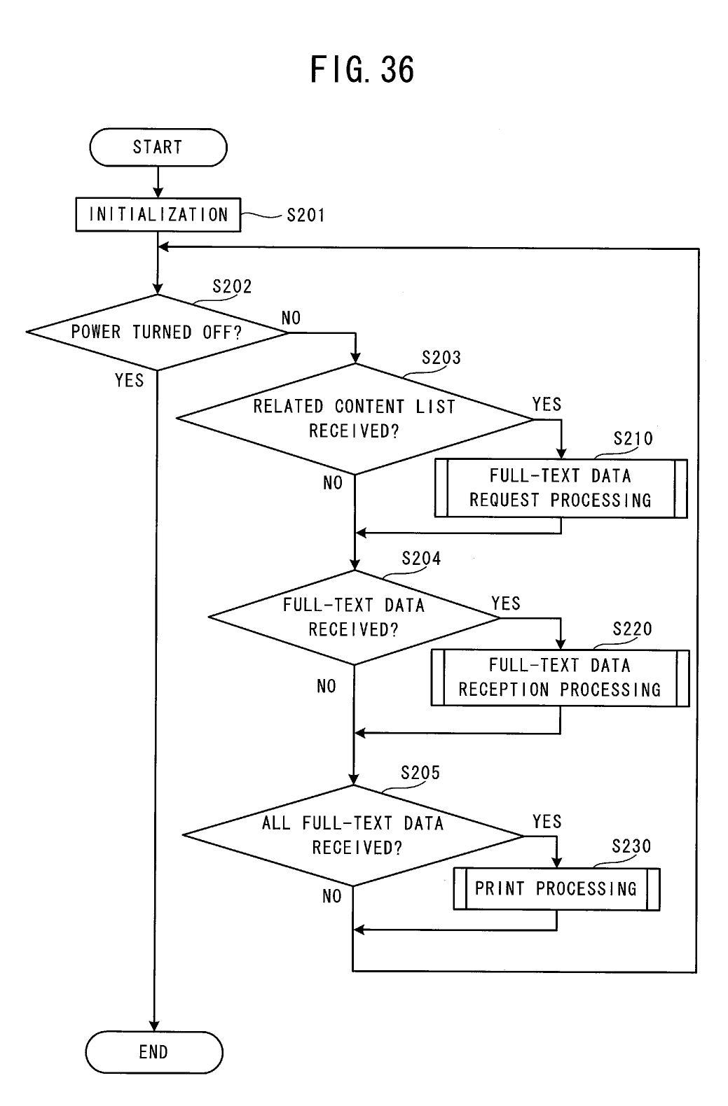

FIGS. 36-40 describe processing to be performed in printer 2, according to an embodiment of the invention. Printer 2 may mediate a request from browsing terminal 1, and may request server 3 to deliver, e.g., transmit, the full-text data of a main article in the newspaper A and the related articles. Further, printer 2 may transfer the full-text data received from server 3 to browsing terminal 1, or may print information depending on a specified output destination. The processing of FIGS. 36-39 may be performed by CPU 20, in accordance with the programs stored in ROM 21.

As shown in FIG. 36, when the power of printer 2 is turned ON to start main processing, CPU 20 first may perform initialization, e.g., clearing each of the storage areas of RAM 22, at Step S201. If the power is turned OFF after the initialization, e.g., YES at Step S202, CPU 20 may terminate the main processing shown in FIG. 36. While the power is not turned OFF, e.g., NO at Step S202, CPU 20 may repeat processing of Steps S203 to S230, as described below.

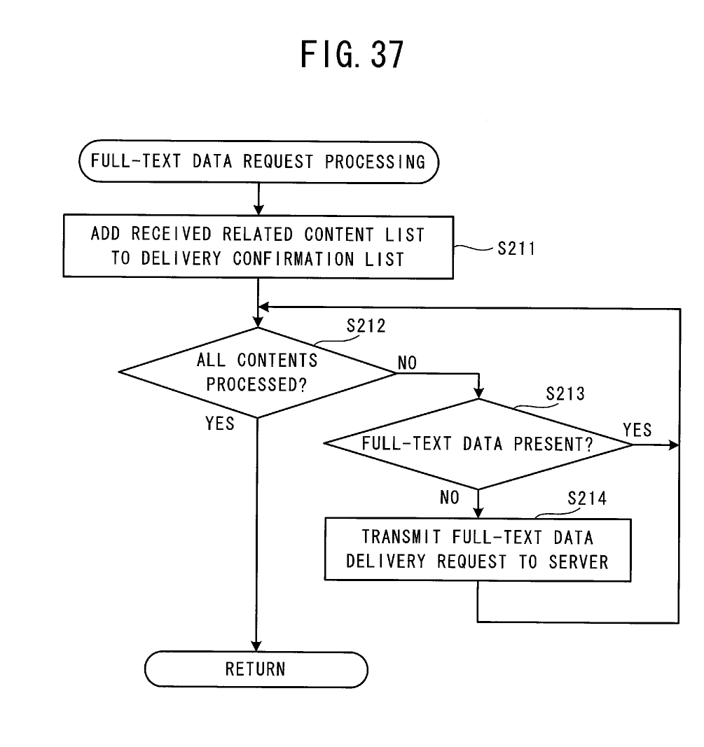

First, the CPU 20 determines whether a related content list, e.g., the content list shown in FIG. 34, and full-text data that are transmitted from the browsing terminal 1 may be received at Step S203. As described above, the full-text data received here may correspond to the data of an article for which the full-text data is stored in browsing terminal 1, among articles included in the related content list, e.g., an article in the newspaper A for which the full-text data is transmitted, e.g., at Step S458 in FIG. 31 or Step S115 in FIG. 32. If printer 2 receives the related content list and the content information including the full-text data that are transmitted from browsing terminal 1, e.g., YES at Step S203, CPU 20 may store the related content list and the content information including the full-text data into related content list storage area 221 and first content information storage area 223 of RAM 22, respectively. Then, the full-text data request processing may be performed at Step S210 in FIG. 37. In the full-text data request processing, server 3 may be requested to deliver, e.g., transmit, the full-text data, if the full-text data of the article in the related content list received from browsing terminal 1 is absent.

Following the start of the full-text data request processing of FIG. 37, CPU 20 may add the related content list, e.g., the related content list shown in FIG. 34, which may be received from browsing terminal 1, to the delivery confirmation list stored in delivery confirmation list storage area 222 of RAM 22, at Step S211. A request ID may serve as an identification code, and may be given to the related content list, and the presence or absence of the full-text data may be stored for each article ID, based on whether the full-text data of the body text is stored in first content information storage area 223.

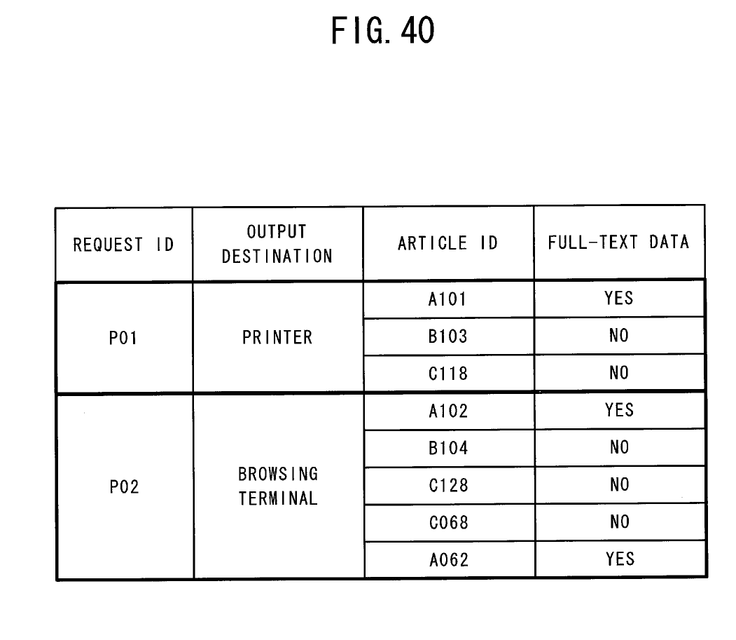

In an embodiment of the invention, the delivery confirmation list stored in delivery confirmation list storage area 222 of printer 2 may be similar to the delivery confirmation list stored in browsing terminal 1, as shown in FIG. 9. Nevertheless, in another embodiment, as shown in FIG. 34, a related content list, including output destination data, may be transmitted from browsing terminal 1 to printer 2. In an embodiment, appropriate processing for each output destination may be performed, and thus the delivery confirmation list for printer 2 may be created, as shown in FIG. 40. Specifically, the delivery confirmation list may comprise a request ID, an output destination, an article ID, and full-text data presence or absence, for each of the received related content lists.

The example of FIG. 40 may show a delivery confirmation list that may be created when two related content lists, respectively having request IDs “P01” and “P02,” are received. The related content list having the request ID “P01” may include printer 2 as the output destination, and may indicate that the full-text data of the body is present for the article ID “A101” in the newspaper A among the three article IDs, and not for the other two article IDs. The related content list having the request ID “P02” may include browsing terminal 1 as the output destination, and may indicate that the full-text data of the body is present for the article IDs “A102” and “A062” in the newspaper A among the five article IDs, and not for the other three article IDs.

CPU 20 then may determine whether the processing has been completed on the article IDs stored in the delivery confirmation list, at Step S212. If the processing has not yet been completed, e.g., NO at Step S212, CPU 20 may determine whether the full-text data of the body is present for the first article ID in the delivery confirmation list at Step S213. If the full-text data is present as in the case of the article ID “A101” in FIG. 40, e.g., YES at Step S213, server 3 may not be requested to deliver, e.g., transmit, the data. Accordingly, CPU 20 may return to Step S212. If the full-text data is absent, as in the case of the article ID “B103” in FIG. 40, e.g., NO at Step S213, CPU 20 may request server 3 to deliver, e.g., transmit, the full-text data of the body text of the article corresponding to that article ID to printer 2, at Step S214. Similarly, CPU 20 may repeat the processing of Steps S212 to S214 to transmit a delivery request to server 3 for those article IDs in the delivery confirmation list for which the full-text data is absent, until the processing has been completed on all of the contents, e.g., YES at Step S212, whereupon CPU 20 may return to the main processing of FIG. 36.

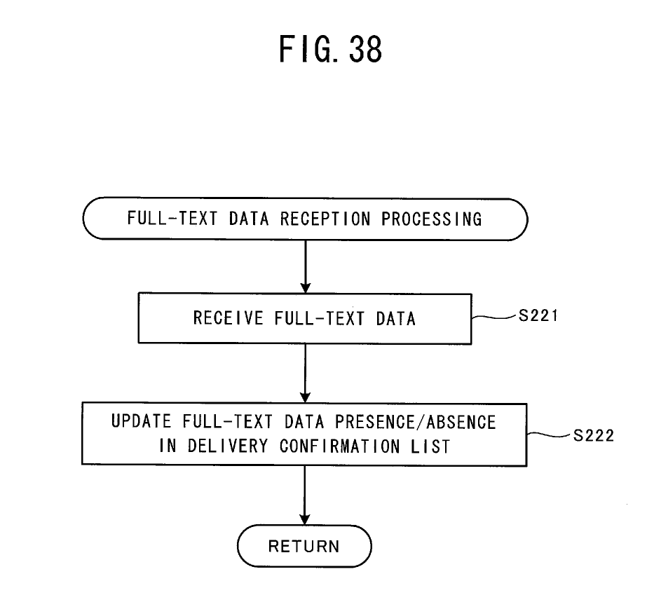

In the main processing of FIG. 36, after the full-text data request processing has been completed at Step S210, or if the related content list is not received from browsing terminal 1, e.g., NO at Step S203, CPU 20 may determine whether content information including the full-text data is received from server 3 at Step S204. If the full-text data transmitted from server 3 in response to a delivery request from printer 2 is received, e.g., YES at Step S204, CPU 20 may perform the full-text data reception processing at Step S220, and shown in FIG. 38. Following the start of the full-text data reception processing shown in FIG. 38, CPU 20 may receive the content information of an article including the full-text data, and may store the received content information into second content information storage area 224 of RAM 22 at Step S221. Then, in the delivery confirmation list, e.g., the delivery confirmation list shown in FIG. 40, stored in delivery confirmation list storage area 222, CPU 20 may update the full-text data presence/absence for the corresponding article ID, with data indicating presence of the full-text data, e.g., YES, and then may return to the main processing of FIG. 36.

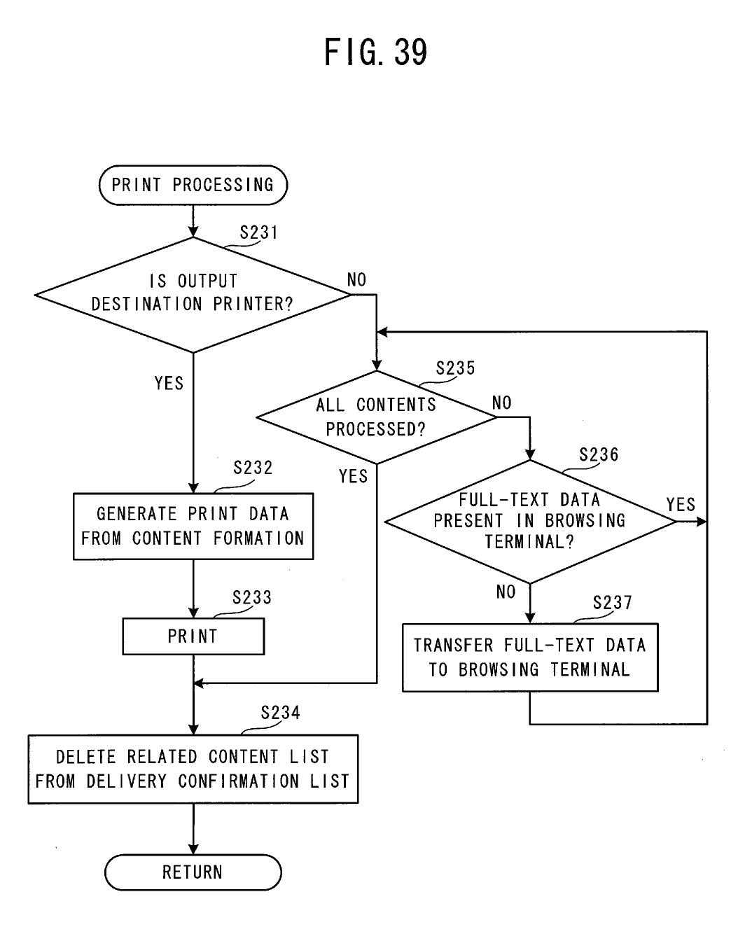

After the full-text data reception processing at Step S220, or if the full-text data is not received, e.g., NO at Step S204, CPU 20 may determine, at Step S205, whether reception of the full-text data has been completed on all of the articles in the related content list for which server 3 is requested to deliver, e.g., transmit, the full-text data. If it is determined that the reception of the full-text data has been completed on all of the articles, e.g., YES at Step S205, CPU 20 may perform print processing at S230 of FIG. 39. In the print processing, if the output destination specified in browsing terminal 1 is printer 2, printing may be performed, and if the output destination is browsing terminal 1, the full-text data may be transferred.

Following the start of the print processing of FIG. 39, CPU 20 may determine whether the output destination is printer 2, with respect to the related content list that may include articles for which the complete full-text data is present in a delivery confirmation list, e.g., the delivery confirmation list of FIG. 40, at Step S231. If the output destination is printer 2, e.g., YES at Step S231, CPU 20 may read out the content information that corresponds to each article ID in the related content list, from first content information storage area 223 or second content information storage area 224. Then, CPU 20 may generate print data from the content information and may store the generated print data into print data storage area 225 at Step S232. CPU 20 may drive and control recording portion 25 based on the generated print data, such that printing may be performed at Step S233.

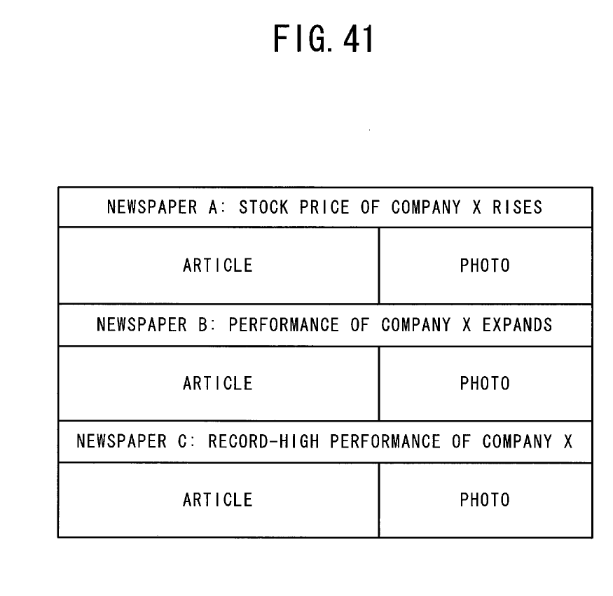

CPU 20 may use, for example, a template stored beforehand to thereby arrange the main article in the newspaper A and the related articles in the newspapers B and C in the same format and layout and print the articles as shown in FIG. 41. This may permit the user of browsing terminal 1 to compare a desired article in the newspaper A and the related articles in any other newspapers printed on a paper while reading. After printing is performed at Step S233, CPU 20 may delete the related content list for which the printing has been completed from the delivery confirmation list, e.g., the delivery confirmation list of FIG. 40, which may be stored in delivery confirmation list storage area 222 at Step S234, and then may return to the main processing of FIG. 36.

If the output destination stored in the delivery confirmation list, e.g., the delivery confirmation list of FIG. 40 is not printer 2, but is browsing terminal 1, e.g., NO at Step S231, CPU 20 may determine whether the processing has been completed on all of the contents, e.g., articles in the related content list, at Step S235. If the processing has not been completed, e.g., NO at Step S235, CPU 20 may perform processing to transmit the full-text data necessary for browsing terminal 1. CPU 20 first may determine whether the full-text data of the first article ID in the related content list is stored in browsing terminal 1 at Step S236. Specifically, if content information having a matching article ID is stored in first content information storage area 223, then content information already may have been received from browsing terminal 1, e.g., Step S458 in FIG. 31, or Step S15 in FIG. 32.

CPU 20 then may determine that the full-text data is stored in the browsing terminal 1, e.g., YES at Step S236. In this case, CPU 20 may not transfer the full-text data to browsing terminal 1, as the full-text data already may have been received, and CPU 20 may return processing to Step S235. If content information having a matching article ID is not stored in first content information storage area 223, then the full-text data may not be stored in browsing terminal 1, e.g., NO at Step S236. CPU 20 then may read out content information having a matching article ID from among the content information stored in the second content information storage area 223, and may transfer the content information to browsing terminal 1 at Step S237.

Then, CPU 20 may returns to Step S235 to repeat the processing of Steps S235 to S237. After the processing to transfer the full-text data to browsing terminal 1 has been completed on all of the contents, e.g., articles in the related content list, e.g., YES at Step S235, CPU 20, at Step S234, may delete the related content list for which the full-text data has been transferred from the delivery confirmation list, and may return to the main processing of FIG. 36.

After the print processing of FIG. 39 is finished at Step S230, or if CPU 20 determines that all of the full-text data has not yet been received, e.g., NO at Step S205, CPU 20 may return processing to Step S202 to repeat the above-described processing of Steps S203 to S230, until the power is turned OFF, e.g., YES at Step S202. If the power is turned OFF at Step S202, the main processing of FIG. 36 may end.

In another embodiment of the invention, server 3 may deliver, e.g., transmit, content information to printer 2 in response to a delivery request from printer 2. Most of the processing in this embodiment is similar to the above-described embodiments, and portions which are the same are omitted. In the another embodiment, when the power of server 3 is turned ON at the server 3 to start the main processing shown in FIG. 24, server 3 may repeat processing to transmit requested data while the power is not turned OFF, e.g., NO at Step S52. When server 3 receives a full-text data delivery request from the printer 2, e, YES at Step S53, CPU 30 in server 3 may read out content information of a requested article ID from the article DB, e.g., the article DB shown in FIG. 10, in article DB storage area 341 in RAM 32, and may transmit the read out content information to the printer 2 at Step S54. After the full-text data is transmitted to printer 2, CPU 30 may return to Step S52 to repeat the processing, until the power is turned OFF, e.g., YES at Step S52.

In another embodiment of the invention, the full-text data of the bodies of articles in the newspaper A regularly may be delivered to browsing terminal 1, while the index information and not the full-text data for other articles in other newspapers required to refer to the related articles of the articles in the newspaper A may be delivered to the browsing terminal 1. If the user wishes to compare a main article and the related articles in the full-text while reading, the user of browsing terminal 1 may generate a list of the articles utilizing the index information and may specify an output destination, e.g., printer 2, and then may transmit the list to printer 2. When printer 2 receives the list, printer 2 may transmit a delivery request for the full-text data of the body of a necessary article to server 3. Therefore, the data storage capacity of browsing terminal 1 may not be increased unnecessarily. Further, if printer 2 is specified as an output destination, articles may be printed on paper by printer 2, which may facilitate ease of reading and comparing the articles by the user.

When server 3 receives the delivery request, server 3 may select the relevant data from the article data accumulated in the article DB and may transmit the data to printer 2. When the data is delivered to printer 2, printer 2 may perform printing if the output destination is printer 2. If the output destination is browsing terminal 1, printer 2 may transfer the full-text data of the body of the article to browsing terminal 1. In this embodiment, content delivery system 101 may accommodate both a case where the user wishes to browse the full-text data on the screen and a case where the user wishes to read the full-text printed on paper.

Further, when the user specifies browsing terminal 1 as the output destination, the full-text data of the body text of a desired article additionally may be delivered to the browsing terminal 1, but if the user does not specify browsing terminal 1 as the output destination, data may not be delivered to browsing terminal 1, which may reduce the frequency with which browsing terminal 1 reaches its data storage capacity.

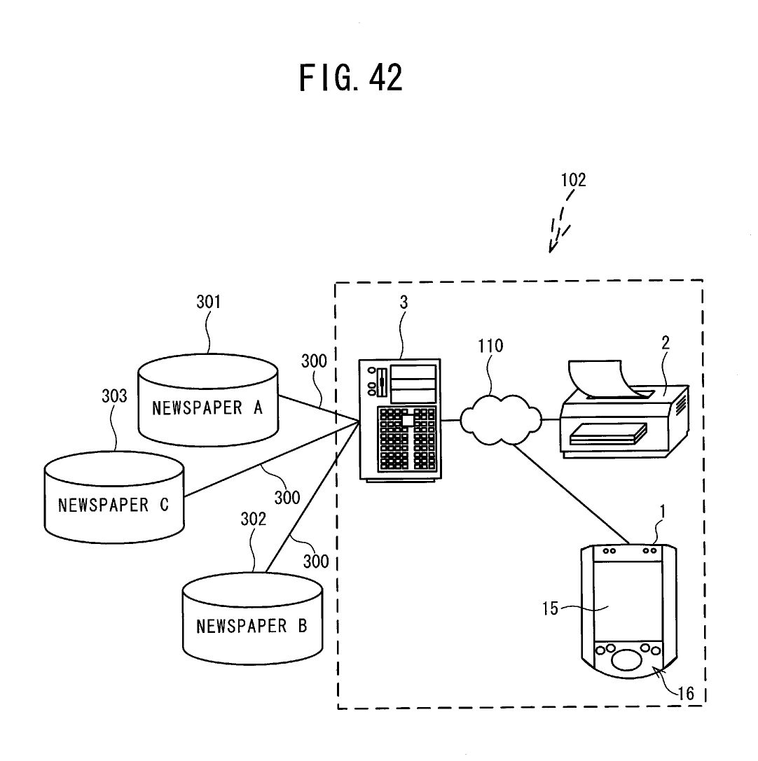

In this embodiment, browsing terminal 1 may be connected to printer 2 via USB cable 181, but optionally may not be connected to server 3. In this embodiment, transmission of a delivery request for the full-text data of the body text of an article from browsing terminal 1, or delivery of the full-text data to browsing terminal 1 may be performed using printer 2. Nevertheless, in another embodiment of the invention, as shown in FIG. 42, a content delivery system 102 may comprise a browsing terminal 1, printer 2, and server 3, which may be connected to each other via a network 110, e.g., the Internet. In this embodiment, browsing terminal 1 may directly request server 3 to deliver, e.g., transmit, the full-text data, and server 3 may transmit the full-text data directly to browsing terminal 1 or printer 2, depending on a specified output destination.

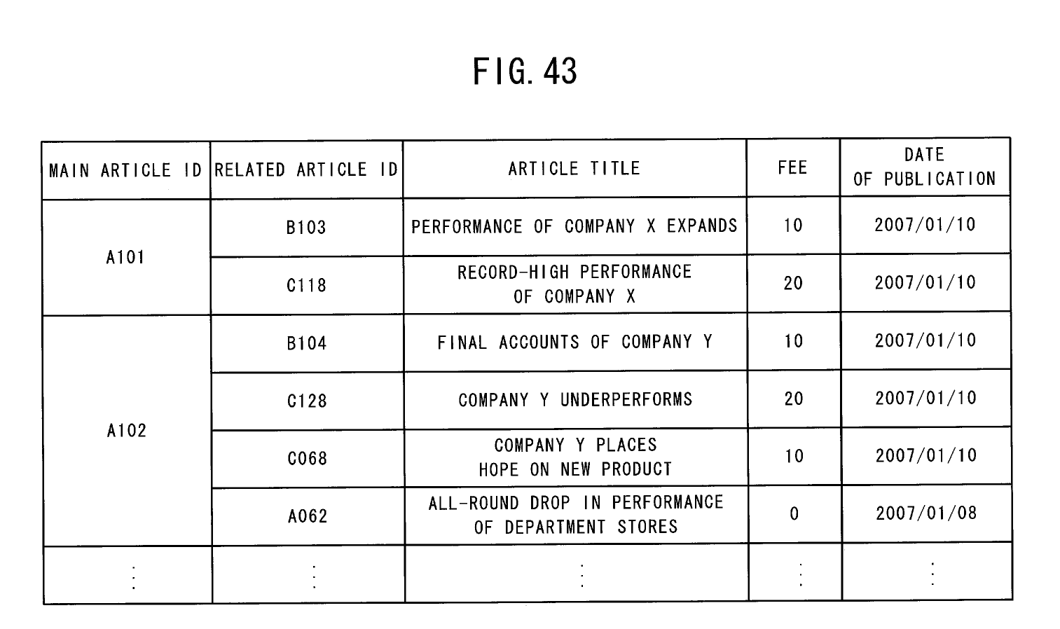

In still another embodiment, as shown in FIG. 43, the index information may comprise a main article ID, a related article ID, an article title, a fee, and a date of publication. The fee may indicate an amount of money to be charged for the delivery of the full-text data of the related article, and the date of publication may indicate a date on which the related article was published. Therefore, in a case where such index information as shown in FIG. 43 is stored, the fee and the date of publication may be displayed together with other information on the related content display screen 151 when the screen appears on the display portion 15. This information may be useful to the user of browsing terminal 1, because the user may determine whether to instruct the delivery of the full-text data of the related articles.

In still another embodiment, in a case in which the user performs content request operations from browsing terminal 1, browsing terminal 1 may transmit a related content list to printer 2, and printer 2 may print the articles uniformly, based on the full-text data delivered from server 3. Such uniform processing may facilitate ease of reading and comparing the articles, e.g., newspaper articles, if the articles are printed in the uniform layout on the paper.

In the above-described embodiments, for articles of the newspaper A for which the full-text data of the body may be stored, the content information may be transmitted from browsing terminal 1 to printer 2. It then may be unnecessary for printer 2 to request server 3 to deliver, e.g., transmit, the articles in the newspaper A. However, any other processing may be performed on the full-text data of the bodies of the articles in the newspaper A. For example, information indicating whether the full-text data of the body text of the article is stored in browsing terminal 1 may be included in the related content list, which may improve the processing efficiency. In this example, printer 2 may make a delivery request to server 3 based on the output destination, which also may improve processing efficiency. Further, if the full-text data already stored in browsing terminal 1 is separately updated in the server 3, the most recent full-text data may be obtained, which may be advantageous.

Specifically, if the output destination is browsing terminal 1, CPU 20 of printer 2 may request server 3 to deliver, e.g., transmit, the full-text data that is not stored in browsing terminal 1 and transmit the received full-text data to browsing terminal 1. If the output destination is printer 2, regardless of the contents of browsing terminal 1, CPU 20 may request server 3 to deliver, e.g., transmit, the full-text data of all of the main article and the related articles and print the received full-text data. In this example, the full text data of the main article and the related articles may be delivered together from server 3 to printer 2.

While the invention has been described in connection with preferred embodiments, it will be understood by those skilled in the art that other variations and modifications of the preferred embodiments described above may be made without departing from the scope of the invention. Other embodiments will be apparent to those skilled in the art from a consideration of the specification or practice of the invention disclosed herein. It is intended that the specification and the described examples are considered as exemplary of the claimed invention, the scope of which is indicated by the following claims.

1. A content delivery system configured to store at least one first content and at least one second content, the content delivery system comprising:
a browsing terminal comprising:
a content storage device configured to store at least one first content;
an identification storage device configured to store at least one identifier, wherein each of the at least one identifier identifies one of the at least one second content, and each of the at least one second content is related to at least one of the at least one first content;
a content selection device configured to select one of the at least one first content from the content storage device;
an identification selection device configured to select each of the at least one identifier which identifies the at least one second content which is related to the selected at least one first content; and
a request transmission device configured to transmit a request for the at least one second content which is related to the selected at least one first content; and
a content delivery apparatus configured to connect to the browsing terminal, wherein the content delivery apparatus comprises:
a storage device configured to store the at least one second content; and
a delivery device configured to transmit the at least one second content which is related to the selected at least one first content in response to the request.

2. The content delivery system according to claim 1, wherein the at least one first content comprises full-text data of the at least one first content, and the at least one second content comprises full-text data of the at least one second content.

3. The content delivery system according to claim 1, wherein the browsing terminal further comprises a display device configured to display at least one of the selected at least one first content and the at least one second content which is related to the selected at least one first content.

4. The content delivery system according to claim 3, wherein the delivery device is configured to transmit the at least one second content which is related to the selected at least one first content to the browsing terminal when the request for the at least one second content which is related to the selected at least one first content is received from the request transmission device, and wherein the browsing terminal further comprises a display control device configured to control the display device to display the at least one second content which is related to the selected at least one first content transmitted from the delivery device.

5. The content delivery system according to claim 3, further comprising a printer configured to be connected to at least the content delivery apparatus, wherein the browsing terminal further comprises a delivery destination specification device configured to select one of the browsing terminal and the printer as a delivery destination of the at least one second content related to the selected at least one first content, and the delivery device further is configured to transmit the at least one second content which is related to the selected at least one first content to the delivery destination when the delivery request is received.

6. The content delivery system according to claim 5, wherein the printer comprises:
a printing device configured to print at least one of the selected at least one first content and the at least one second content which is related to the selected at least one first content; and
a print control device configured to control the printing device to print the at least one second content which is related to the selected at least one first content transmitted from the delivery device.

7. The content delivery system according to claim 1, wherein the delivery device is configured to transmit the at least one second content which is related to the selected at least one first content to a printer configured to be connected to at least the content delivery apparatus, wherein the printer comprises:
a printing device configured to print at least the selected at least one first content and the at least one second content which is related to the selected at least one first content; and
a print control device configured to instruct the printing device to print the at least one second content related to the selected at least one first content.

8. A content delivery system configured to store at least one first content and at least one second content, the content delivery system comprising:
a browsing terminal, a content delivery apparatus, and a printer, wherein the browsing terminal is configured to be connected to at least one of the content delivery apparatus and the printer, and the browsing terminal comprises:
a content storage device configured to store at least one first content;
an identification storage device configured to store at least one identifier, wherein each of the at least one identifier identifies one of the at least one second content, and each of the at least one second content is related to at least one of the at least one first content;
a content selection device configured to select one of the at least one first content from the content storage device;
an identification selection device configured to select each of the at least one identifier which identifies the at least one second content which is related to the selected at least one first content; and
a terminal request transmission device configured to transmit a first delivery request for the at least one second content which is related to the selected at least one first content to the printer, wherein the printer comprises:
a printing device configured to print at least the selected at least one first content and the at least one second content which is related to the selected at least one first content; and
a printer request transmission device configured to transmit a second delivery request to the content delivery apparatus, wherein the second delivery request requests delivery of the at least one second content which is related to the selected at least one first content when the first delivery request is received from the terminal request transmission device, and the content delivery apparatus comprises a delivery device configured to transmit the at least one second content which is related to the selected at least one first content to the printer when the second delivery request is received.

9. The content delivery system of claim 8, wherein the browser terminal further comprises a display device configured to display at least the selected at least one first content and the at least one second content which is related to the selected at least one first content.

10. The content delivery system according to claim 8, wherein the printer further comprises a print control device configured to instruct the printing device to print the at least one second content which is related to the selected at least one first content transmitted from the delivery device.

11. The content delivery system according to claim 10, wherein the browsing terminal further comprises a browser print request transmission device configured to transmit a print request to the printer that requests printing of the selected at least one first content and the at least one second content which is related to the selected at least one first content, and wherein the printer further comprises a full-text data acquisition device that is configured to acquire a full-text data of the selected at least one first content from the browsing terminal or the content delivery apparatus when the print request is received from the browser print request transmission device, and the print control device is configured to instruct the printing device to print the selected at least one first content and the at least one second content which is related to the selected at least one first content.

12. The content delivery system according to claim 1, wherein the printer is configured to print the selected at least one first content and the at least one second content which is related to the selected at least one first content in a common format and a common layout based on the at least one second content which is related to the selected at least one first content transmitted from the delivery device and the full-text data of the selected at least one first content acquired by the full-text data acquisition device.

13. The content delivery system according to claim 11, wherein the browsing terminal further comprises a full-text data transmission device configured to transmit the full-text data of the selected at least one first content to the printer, when the print request is transmitted by the browser print request device; and
the full-text data acquisition device is configured to acquire the full-text data of the selected at least one first content transmitted by the full-text data transmission device.

14. The content delivery system according to claim 11, wherein the printer request transmission device is further configured to transmit a third delivery request to the content delivery apparatus, wherein the third delivery request requests delivery of the full-text data of the selected at least one first content together with a full-text data of the at least one second content which is related to the selected at least one first content, when the print request is received from the browser print request transmission device; and
the delivery device is configured to deliver the full-text data of the selected at least one first content together with the full-text data of the at least one second content which is related to the selected at least one first content to the printer when the third delivery request is received from the printer request transmission device.

15. The content delivery system according to claim 9, wherein the browsing terminal further comprises:
a delivery destination specification device configured to specify either one of the browsing terminal and the printer as a delivery destination of the at least one second content which is related to the selected at least one first content; and
a display control device configured to control the display device to display the at least one second content which is related to the selected at least one first content when the browsing terminal is specified as the delivery destination of the at least one second content which is related to the selected at least one first content,
wherein the terminal request transmission device is configured to transmit to the printer the first delivery request for the at least one second content which is related to the selected at least one first content to the delivery destination specified by the delivery destination specification device, and
the printer further comprises a transfer device configured to transfer the at least one second content which is related to the selected at least one first content transmitted from the delivery device to the browsing terminal if the delivery destination of the first delivery request received from the terminal request transmission device is the browsing terminal.

16. A browsing terminal configured to store at least one first content and to request at least one second content, the browsing terminal comprising:
a content storage device configured to store at least one first content;
an identification storage device configured to store at least one identifier, wherein each of the at least one identifier identifies one of the at least one second content, and each of the at least one second content is related to at least one of the at least one first content;
a content selection device configured to select one of the at least one first content from the content storage device;
an identification selection device configured to select each of the at least one identifier which identifies the at least one second content which is related to the selected at least one first content; and
a request transmission device configured to transmit a request for the at least one second content which is related to the selected at least one first content.

17. The browsing terminal of claim 16, wherein the browsing terminal is configured to be connected to at least one of a content delivery apparatus and a printer.

18. The browsing terminal of claim 17, wherein the browsing terminal further comprises a display device configured to display at least one of the selected at least one first content and the at least one second content which is related to the selected at least one first content.

19. The browsing terminal according to claim 18, further comprising a first display control device that is configured to instruct the display device to display the at least one second content which is related to the selected at least one first content based on the at least one second content which is related to the selected at least one first content transmitted in response to the request.

20. The browsing terminal according to claim 17, further comprising a print request transmission device that transmits, to the printer, a print request that requests printing of the selected at least one first content and the at least one second content which is related to the selected at least one first content.

21. The browsing terminal according to claim 20, further comprising a full-text data transmission device that is configured to transmit a full-text data of the selected at least one first content to the printer when the print request is transmitted by the print request transmission device.

22. The browsing terminal according to claim 17, further comprising a delivery destination specification device that is configured to specify one of the browsing terminal and the printer as a delivery destination of the at least one second content which is related to the selected at least one first content.

23. The browsing terminal according to claim 18, wherein a predetermined number of second contents which are related to the selected at least one first content is greater than one second content, and the browsing terminal further comprises:
a second display control device configured to instruct the display device to display the identifier for each of the predetermined number of second contents which are related to the selected at least one first content; and
a contents specification device configured to select a particular number of the at least one second content which is related to the selected at least one first content from the predetermined number, for which delivery of a full-text data is to be requested, and wherein the request transmission device is configured to transmit a request to transmit the particular number of the at least one second content which is related to the selected at least one first content, wherein the particular number is less than or equal to the predetermined number.

24. The browsing terminal according to claim 23, wherein each of the at least one identifier that identifies one of the at least one second content comprises one or more of a title, a date of publication, and a fee associated with transmitting the at least one second content which is related to the selected at least one first content.

25. The browsing terminal according to claim 17, further comprising:
a request storage device that stores the request; and
a connection detection device configured to detect whether the browsing terminal is connected to the content delivery apparatus or to the printer, wherein the request transmission device is configured to transmit the request when the connection detection device detects that the browsing terminal is connected to the content delivery apparatus or to the printer.

26. The browsing terminal according to claim 16, wherein the identifier for each of the at least one second content which is related to the selected at least one first content is related to the selected at least one first content using a tag.

27. A method of delivering contents, wherein the contents comprise at least one first content and at least one second content, the method comprising the steps of:
storing at least one first content;
storing at least one identifier, wherein each of the at least one identifier identifies one of the at least one second content, and each of the at least one second content is related to at least one of the at least one first content;
selecting one of the at least one first content;
selecting each of the at least one identifier which identifies the at least one second content which is related to the selected at least one first content; and
transmitting a request for the at least one second content which is related to the selected at least one first content to be transmitted; and
receiving the at least one second content which is related to the selected at least one first content.

28. The method of claim 27, further comprising the step of displaying at least one of the at least one content and the at least one second content which is related to the selected at least one first content on a display device.

29. A computer-readable recording medium having computer readable instructions stored thereon, for enabling a browsing terminal to execute a content delivery request control program, wherein execution of the computer readable instructions enables the browsing terminal to execute the program, including operations for storing at least one first content and requesting at least one second content, the operations comprising the steps of:
storing at least one first content;
storing at least one identifier, wherein each of the at least one identifier identifies one of the at least one second content, and each of the at least one second content is related to at least one of the at least one first content;
selecting one of the at least one first content;
selecting each of the at least one identifier which identifies the at least one second content which is related to the selected at least one first content; and
transmitting a request for the at least one second content which is related to the selected at least one first content to be transmitted either to the browsing terminal or to a printer.

30. The computer-readable recording medium according to claim 29, wherein the program operations further comprise the step of displaying at least one of the at least one first content and the at least one second content which is related to the selected at least one first content on a display device.

31. The computer-readable recording medium according to claim 29, wherein the program operations further comprise the step of transmitting, to a printer, a print request that requests printing of the at least one second content which is related to the selected at least one first content, and of the selected at least one first content.

32. The computer-readable recording medium according to claim 31, wherein the program operations further comprise the step of transmitting a full-text data of the selected at least one first content to a printer, when transmitting the request to transmit the at least one second content which is related to the selected at least one first content.

33. The computer-readable recording medium according to claim 29, wherein the program operations further comprise the step of specifying either one of the browsing terminal or to a printer as a delivery destination of the at least one second content which is related to the selected at least one first content.

34. The computer-readable recording medium according to claim 30, wherein a predetermined number of second contents which are related to the selected at least one first content is greater than one second content, and the program operations further comprise the steps of:
displaying, on the display device, the identifier for each of the predetermined number of second contents which are related to the selected at least one first content; and
selecting a particular number of the at least one second content which is related to the selected at least one first content from the predetermined number, wherein the particular number is less than or equal to the predetermined number, and the step of transmitting the request comprises transmitting a request to transmit the particular number of the at least one second content which is related to the selected at least one first content.

35. The computer-readable recording medium according to claim 34, wherein each of the at least one identifier comprises at least one of a title, a date of publication, and a fee associated with transmitting the at least one second content which is related to the selected at least one first content.

36. The computer-readable recording medium according to claim 29, wherein the program operations further comprise the steps of:
detecting whether the browsing terminal is connected to the content delivery apparatus or to the printer; and
transmitting the request to transmit the at least one second content when it is detected that the browsing terminal is connected to a content delivery apparatus or to the printer.

37. The computer-readable recording medium according to claim 29, wherein the identifier for each of the at least one second content which is related to the selected at least one first content is related to the selected at least one first content using a tag.
